(19) United States
(12) Patent Application Publication
(10) Pub. No.: US 2023/0049383 A1
(43) Pub. Date: Feb. 16, 2023

(54) SYSTEMS AND METHODS FOR DETERMINING ROAD TRAVERSABILITY USING REAL TIME DATA AND A TRAINED MODEL

(71) Applicant: Sensible 4 Oy, Espoo (FI)

(72) Inventors: Miika Lehtimäki, Espoo (FI); Jari Saarinen, Espoo (FI); Ashish Khatke, Espoo (FI); Enes Özipek, Espoo (FI); Teemu Kuusisto, Espoo (FI); Hamza Hanchi, Espoo (FI)

(73) Assignee: Sensible 4 Oy, Espoo (FI)

(21) Appl. No.: 17/871,880

(22) Filed: Jul. 22, 2022

Related U.S. Application Data
(60) Provisional application No. 63/225,354, filed on Jul. 23, 2021.

(51) Int. Cl. G06V 20/56; G06V 10/74; G01S 17/89; G01S 17/86

(52) U.S. Cl. CPC G06V 20/588; G06V 10/74; G01S 17/89; G01S 17/86

(57) ABSTRACT

Embodiments of the disclosed systems and methods provide for determination of roadway traversability by an autonomous vehicle using real time data and a trained traversability determination machine learning model. Consistent with aspects of the disclosed embodiments, the model may be trained using annotated birds eye view perspective data obtained using vehicle vision sensor systems (e.g., LiDAR and/or camera systems). During operation of a vehicle, vision sensor data may be used to construct birds eye view perspective data, which may be provided to the trained model. The model may label and/or otherwise annotate the vision sensor data based on relationships identified in the model training process to identify associated road boundary and/or lane information. Local vehicle control systems may compute control actions and issue commands to associated vehicle control systems to ensure the vehicle travels within a desired path.

### RELATED APPLICATIONS

This application claims benefit of priority under 35 U.S.C. § 119(e) to U.S. Provisional Patent Application No. 63/225,354, filed Jul. 23, 2021, and entitled “SYSTEMS AND METHODS FOR DETERMINING ROAD TRAVERSABILITY USING REAL TIME DATA AND A TRAINED MODEL,” which is incorporated herein by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to systems and methods for managing and processing data associated with autonomous vehicles (“AVs”). More specifically, but not exclusively, the present disclosure relates to systems and methods for determining roadway traversability by an AV using real time data and a trained traversability determination model.

Existing lane identification and/or tracking solutions for advanced driver-assistance systems (“ADAS”) that may be implemented in autonomous, self-driving, and/or semi-autonomous vehicles generally depend on the availability and/or visibility of lane markings. For safe operation, a driver of a vehicle implementing such existing ADAS solutions may be responsible to keep their hands on the steering wheel so that they may quickly react in the event they are required to engage in manual control and/or intervention in the operation of the vehicle. Many roadways, however, lack lane and/or other roadway identification markings. Additionally, certain weather conditions, such as snow packed road conditions, may obscure lane markings (or other objects that may be used to identify a lane such as other vehicles) from vehicle sensors.

Embodiments of the disclosed systems and methods may provide enhanced traversability perception over conventional ADAS solutions. In some embodiments, the disclosed systems and methods may first build and train a model using test and/or characterization data associated with a path and/or roadway obtained using one or more vehicle sensors. Raw test and/or characterization data may be processed to identify road boundary information (e.g., traversable areas along a path and/or road) and/or lane estimations within the identified road boundary information. In some embodiments, such processing may involve annotation of the data.

In various embodiments, test and/or characterization data may be annotated by fusing the data into a cohesive spatial model combining light detection and ranging (“LiDAR”) and/or camera information. In some embodiments, this cohesive spatial model may comprise birds eye view (“BEV”) perspective data, although other data types and/or models and/or combinations thereof may also be employed. The combined vision sensor data may be annotated by selecting estimated roadway boundaries and/or lanes within estimated roadway boundaries. The annotated data may be provided to a machine learning model trained to identify relationships between the test and/or characterization data and the annotated road boundary and/or lane information.

During operation of a vehicle, vision sensor data, which may include LiDAR and/or camera data, may be provided to the trained model, potentially in real-time and/or substantially real time. The model may be configured to label and/or otherwise annotate the vision sensor data, which in certain instances herein may be referred to as real-time sensor data, based on relationships identified in the model training process to identify road boundary information associated with the data. The model may further be configured to identify lane information within the identified road boundaries associated with the real-time vision sensor data. Local vehicle control systems may compute any control actions, which may comprise corrective control actions, and issue commands to associated vehicle control and/or propulsion systems to ensure the vehicle travels within and/or substantial within identified boundaries and/or lanes and/or travels along and/or substantially along a designated lateral position within identified road boundaries and/or lanes.

In various embodiments, by projecting globally aligned camera images on a ground level estimate, which may be referred to in certain instances herein as a heightmap, a cohesive spatial model comprising BEV data may be generated. In certain embodiments, the cohesive spatial model may comprise a BEV image resembling a satellite image. Annotating and/or labeling this global image may allow for a road and/or lane boundary label to be virtually recreated for multiple viewpoints given a sufficiently accurate heightmap. This may, among other things, significantly reduce workloads associated with labeling, annotating, and/or otherwise identifying roadway and/or lane boundaries, as significantly fewer images may need to be labeled. For instance, in at least one non-limiting example, embodiments of the disclosed systems and methods may reduce the total labeling workload from potentially thousands of images to one for a particular area surrounding a vehicle.

### BRIEF DESCRIPTION OF THE DRAWINGS

The inventive body of work will be readily understood by referring to the following detailed description in conjunction with the accompanying drawings, in which:

FIG. 1 illustrates a non-limiting example of a roadway traversability determination processes using real-time data and a trained model consistent with certain embodiments of the present disclosure.

FIG. 2 illustrates a non-limiting example of processed vision sensor data that has been annotated to identify road boundaries consistent with certain embodiments of the present disclosure.

FIG. 3 illustrates a non-limiting example of processed vision sensor data that has been annotated to identify a lane within identified road boundaries consistent with certain embodiments of the present disclosure.

FIG. 4 illustrates a conceptual diagram of a non-limiting example of a first aspect of processing sensor data for training a machine learning model consistent with certain embodiments disclosed herein.

FIG. 5 illustrates a non-limiting example of a point angle nonlinearization function and its inverse for point cloud spherical augmentation consistent with certain embodiments disclosed herein.

FIG. 6 illustrates a non-limiting example of the effects of a polar angle projection nonlinearization scheme consistent with certain embodiments disclosed herein.

FIG. 7 illustrates a non-limiting example of iterative closest point alignment in the presence of noise in a target point cloud consistent with certain embodiments disclosed herein.

FIG. 8 illustrates a non-limiting example of iterative closest point alignment in the presence of density distribution dissimilarity consistent with certain embodiments disclosed herein.

FIG. 9 illustrates a non-limiting example of iterative closest point alignment in case of poor initial alignment consistent with certain embodiments disclosed herein.

FIG. 10 illustrates a non-limiting example of a kernel density estimation approximation process consistent with certain embodiments disclosed herein.

FIG. 11 illustrates a conceptual diagram of a non-limiting example of a second aspect of processing sensor data for training a machine learning model consistent with certain embodiments disclosed herein.

FIG. 12 illustrates a non-limiting example of the results of LiDAR point cloud triangulation and image projection consistent with certain embodiments disclosed herein.

FIG. 13 illustrates a non-limiting example of frame concatenation consistent with certain embodiments disclosed herein.

FIG. 14 illustrates a first non-limiting example of a machine learning model training network consistent with certain embodiments disclosed herein.

FIG. 15 illustrates a second non-limiting example of a machine learning model training network consistent with certain embodiments disclosed herein.

FIG. 16 illustrates a first non-limiting example of a convolution module consistent with certain embodiments disclosed herein.

FIG. 17 illustrates non-limiting examples of down and upscaling modules consistent with certain embodiments disclosed herein.

FIG. 18 illustrates a flow chart of a non-limiting example of a method of training and validating a machine learning model for determining road traversability consistent with certain embodiments disclosed herein.

FIG. 19 illustrates a flow chart of a non-limiting example of a method of using a validated trained machine learning model in connection with road traversability determinations in a vehicle consistent with certain embodiments disclosed herein.

FIG. 20 illustrates a non-limiting example of a system that may be used to implement certain embodiments of the systems and methods of the present disclosure.

FIG. 21 illustrates a non-limiting example of a simplified vehicle architecture that may be used to implement certain embodiments of the systems and methods of the present disclosure.

### DETAILED DESCRIPTION

A description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may in some instances be designated by like numbers and/or descriptions. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods may use raw characterization and/or test data that has been processed and/or annotated (e.g., annotated to identify road boundary information and/or lane information within the identified road boundary information) to train a machine learning model designed to identify relationships between the raw characterization and/or test data and the annotated road boundary and/or lane information. During operation of a vehicle, vision sensor data including LiDAR and/or camera data may be fed in real-time to the trained model. The model may be configured to identify lane information within the identified road boundaries associated with the real-time vision sensor data. Local vehicle control may compute any corrective control actions required to maintain a designated lateral position and/or position range within an identified lane.

Although various embodiments are generally described herein as being used in connection with AVs for purposes of illustration and explanation, it will be appreciated that the described embodiments of the disclosed systems and methods may be used in connection with fully autonomous, semi-autonomous, and/or other assisted driving vehicles (e.g., assisted driving vehicles driven at least in part by an in-vehicle driver and/or a remote operator). Moreover, it will be appreciated that various aspects of the disclosed embodiments may be used in connection with a variety of types of vehicles including, for example and without limitation, passenger vehicles, transit vehicles, freight vehicles, land-based vehicles, watercraft, aircraft, and/or the like.

Traversability Model Training and Vehicle Control

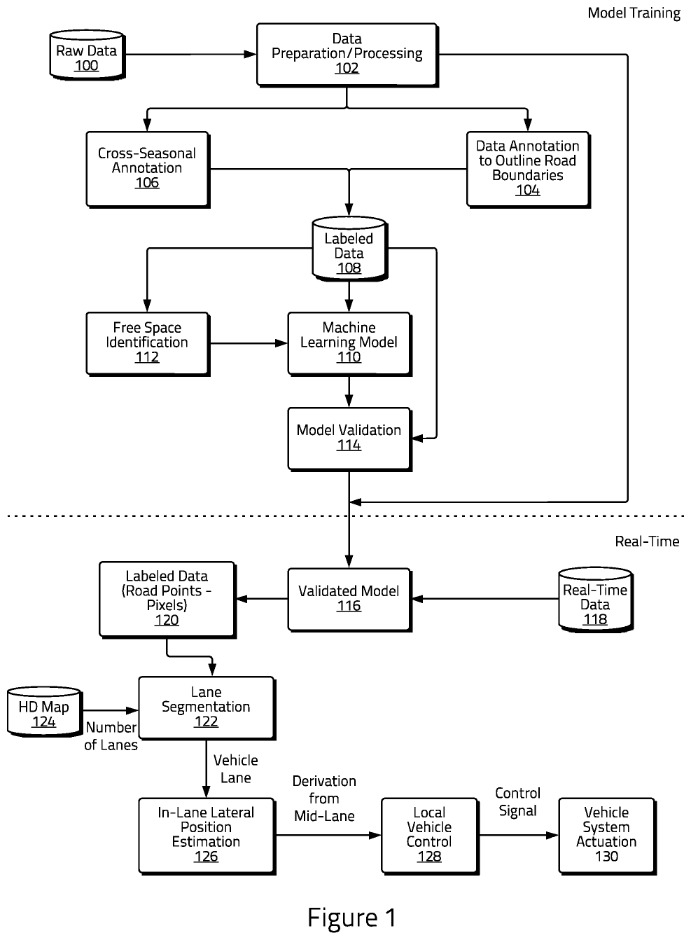

FIG. 1 illustrates a non-limiting example of a roadway traversability determination processes using real-time data and a trained model consistent with certain embodiments of the present disclosure. As illustrated, raw test and/or characterization data 100 (terms which may in some instances be generally used interchangeably herein) associated with a path and/or roadway may be obtained using one or more vehicle sensors. In various instances herein, a path and/or roadway (terms which may in some instances be generally used herein interchangeably) may comprise any improved roadway (e.g., a paved roadway, potentially with or without lane markers, curbing, and/or other roadway features) and/or an unimproved roadway and/or path (e.g., gravel and/or dirt roadways, and/or other paths that may be traversable by a vehicle, even if not specifically intended as a roadway).

Vehicle sensors may comprise, for example and without limitation, LiDAR sensors, radio detection and ranging (“RADAR”) sensors, vision sensors (e.g., cameras), and/or any other suitable type of vehicle sensor and/or combination of sensors. Test and/or characterization data 100 may be obtained by driving a vehicle along a roadway and/or path (e.g., under manual control) and recording the data 100 obtained by one or more vehicle sensors as the vehicle traverses the roadway and/or path. In some embodiments, test and/or characterization data 100 may be obtained by driving the vehicle under manual control, although various types of autonomous operation may also be used in connection with obtaining test and/or characterization data 100 including, for example and without limitation, fully autonomous, semi-autonomous, and/or other assisted driving operations.

In various embodiments, raw test and/or characterization data 100 may be obtained when the vehicle is operating under a variety of different types of weather and/or road conditions. For example, raw test and/or characterization data 100 may be obtained during sunny conditions with bare pavement, rainy conditions with more limited sensor visibility and/or accuracy, snow packed conditions with potential limited visibility and/or less visibility (if not entirely obscured) lane markings, and/or the like. By collecting test and/or characterization data 100 under different types of weather and/or road conditions, various embodiments of the disclosed systems and methods may be used to generate a validated machine learning model that may be used under a variety of different weather and/or road conditions, as discussed in more detail below. Further embodiments of the disclosed systems and methods may use raw test and/or characterization data 100 obtained on roadways with no lane markings (e.g., as may be the case with a gravel road)

The raw test and/or characterization data 100 may be prepared, processed, and/or otherwise formatted 102 so that it can be more readily annotated. In various embodiments, the raw test and/or characterization data 100 may comprise vision sensor data (e.g., camera data, LiDAR point cloud data, etc.) representative of a roadway, path, and/or an area and/or environment surrounding a vehicle and/or a roadway and/or path (e.g., roadside objects and/or features, roadside topographic features, etc.).

Consistent with embodiments disclosed herein, the processed test and/or characterization data may be annotated 104—either automatically, manually by a user, semi-supervised with assistance of a user, and/or using combinations thereof—to facilitate training of a machine learning model. In some embodiments, the processed test and/or characterization data may be annotated 104 using one or more suitable techniques to identify road boundary information (e.g., road traversable areas) and/or lane estimations within the identified road boundary information.

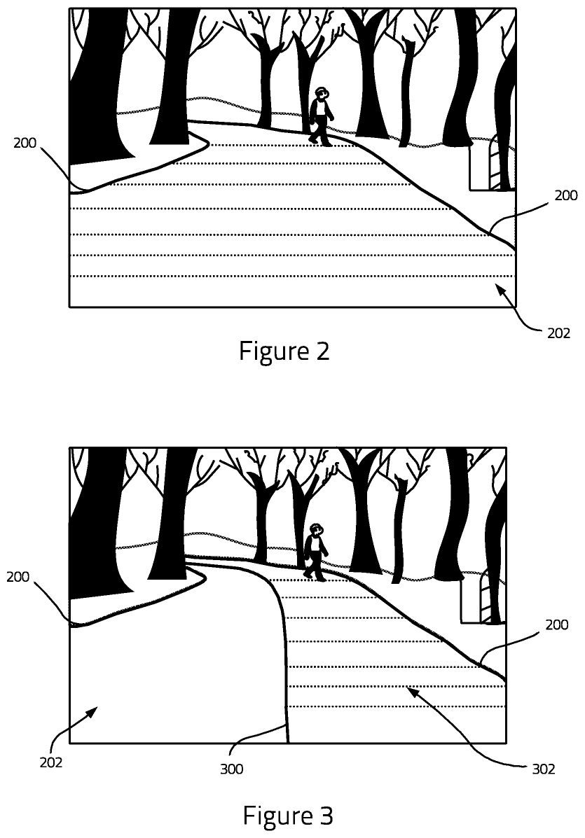

FIG. 2 illustrates a non-limiting example of processed vision sensor data that has been annotated to identify roadway boundaries 200 consistent with certain embodiments of the present disclosure. As shown, vision sensor data may be used to generate and/or otherwise provide an image of a roadway 202 in front of and/or behind a vehicle. The roadway image 202 may be annotated to identify roadway boundaries 200 within the areas of the image corresponding to the traversable roadway. Although not specifically illustrated in FIG. 2, in some embodiments the roadway image may comprise BEV perspective image data

Similarly, FIG. 3 illustrates a non-limiting example of processed vision sensor data that has been annotated to identify one or more lane boundaries 300 within identified roadway boundaries 200 consistent with certain embodiments of the present disclosure. For example, as shown, a lane 302 associated with one or more lane boundaries 300 may be defined within the traversable path associated with the identified roadway boundaries 200.

Referring back to FIG. 1, in some embodiments, processed test and/or characterization data may be captured, recorded, and/or otherwise generating during different seasons and/or under different weather and/or visibility conditions. For example and without limitation, processed test and/or characterization data associated with a roadway may be obtained and/or generated under reference (e.g., ideal) weather and/or visibility conditions and annotated. In some embodiments, processed test and/or characterization data generated under reference weather and/or visibility conditions may be used to annotate data associated with less ideal and/or more severe weather conditions with more limited visibility 106. In further embodiments, processed test and/or characterization data generated under non-reference weather conditions may be annotated 106 independent of the reference data annotation.

The raw test and/or characterization data 100 may be prepared, processed, and/or otherwise formatted 102 so that it can be more readily annotated in a variety of ways. In some embodiments, data formatting 102 may comprise fusing data to cohesive spatial model combining, for example and without limitation, LiDAR, camera, and/or other vision sensor information. Consistent with embodiments disclosed herein, this cohesive spatial model may comprise BEV perspective data, although other data types and/or models and/or combinations thereof may also be employed. In various embodiments, use of BEV perspective data may provide certain advantages in terms of data annotation, model training, environmental condition detection, and/or route planning. As noted above, the combined vision sensor data included in the processed test and/or characterization data may be annotated 104 (potentially under different weather and/or environmental conditions 106) using any suitable techniques and/or combinations thereof by selecting estimated roadway boundaries and/or associated lanes within the roadways.

The resulting annotated data, which in certain instances herein may be referred to as annotated and/or labeled data 108, may be provided to a machine learning model 110. Consistent with embodiments disclosed herein, the machine learning model 110 may be trained using the labeled data 108. For example, the machine learning model 110 may be trained using the labeled data 108 to identify relationships between the test and/or characterization data (e.g., raw and/or pre-processed test and/or characterization data 100) and the annotated road boundary and/or lane information.

In some embodiments, free space identification techniques 112 may be used in connection with training the machine learning model 110. For example, in some embodiments, free space and/or obstacles surrounding the vehicle may be identified in the labeled data 108 and used in connection with improving the training of the machine learning model 110.

After training, the machine learning model 110 may be validated 114 using additional test and/or characterization data (e.g., additional labeled data 108, potentially different than the data used to originally train the machine learning model 110) to provide an estimate of model quality. If estimation quality of the machine learning model 110 meets certain threshold quality measures, the model may be deployed for use in vehicle operation as a validated model 116. Otherwise, the model machine learning model 110 may continue to be trained with additional labeled test and/or characterization data 108 until the model's 110 estimation quality meets desired and/or otherwise specified thresholds.

During operation of a vehicle, sensor data 118 including, for example and without limitation, vision sensor data such as LiDAR and/or camera data, may be fed to the trained and validated model 116. The model 116 may be configured to label and/or otherwise annotate the sensor data 118, which may comprise real time data, based on relationships identified in the training process to identify road boundary information associated with the data. In certain embodiments, the resulting labeled data 120 may be represented as road points and/or pixels within a BEV projection.

In some embodiments, lane information (and/or road boundary information) may be identified using a lane segmentation process 122 to identify lane boundaries within identified road boundaries. In certain embodiments, the lane segmentation process 122 may use mapping information 124 (e.g., high-definition mapping information). For example and without limitation, in some embodiments, mapping information 124 may comprise an indication of a number of lanes on a roadway, which may be used by lane segmentation processes 122 to identify lane boundaries within identified roadway boundaries, potentially in conjunction with available vehicle location information.

The lateral position of the vehicle within the identified lane boundaries may be determined 126. In some embodiments, the lateral position of the vehicle may be estimated and/or otherwise expressed as deviation from a mid-lane position within lane boundaries. Local vehicle control 128 may compute any corrective control actions required for the vehicle to return to a designated lateral position, which may comprise a mid-lane position, and/or position range within an identified lane. Associated control action signals may be communicated the vehicle control systems which may implement the control actions 130.

As discussed above, in certain embodiments, test and/or characterization data captured by one or more vehicle sensors may be used to generate a cohesive spatial model used to train the machine learning model 110 for determining road traversability (e.g., road and/or lane boundary information). In some embodiments, the cohesive spatial model may comprise BEV perspective data. Consistent with embodiments disclosed herein vision data associated with driving sequences (e.g., 1 minute driving sequences) may be used to generate corresponding BEV perspective data. Data associated with the driving sequences may be covered into global BEV images that may be labeled. Input-output pairs of BEV frames may then be generated for training the machine learning model 110.

Sensor Data Processing

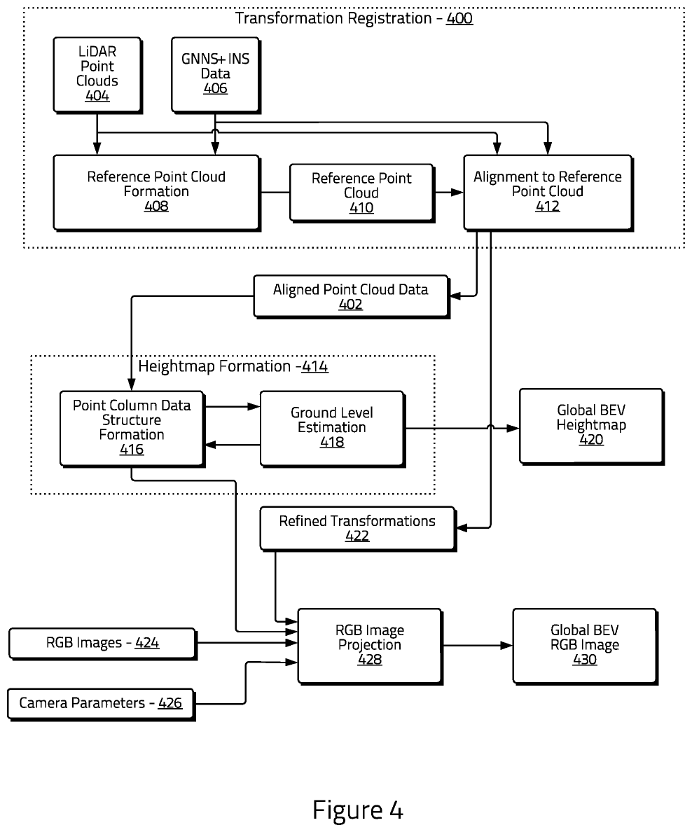

FIG. 4 illustrates a conceptual diagram of a non-limiting example of a first aspect of processing sensor data used to train a machine learning model consistent with certain embodiments disclosed herein. In some embodiments, a transformation registration process 400 may be used to generate aligned point cloud data 402 used in connection with a heightmap formation process 414. The transformation registration process 400 may use LiDAR point cloud data 404 obtained from vehicle sensor systems and Global Navigation Satellite System+Inertial Navigation System (“GNSS+INS”) data 406 to generate reference point cloud data 410 using a reference point cloud formation process 408. The reference point cloud data 410 may be used to align updated LiDAR point cloud data 404 and/or GNSS+INS data 406 with the generated reference point cloud data 410 to generate aligned point cloud data 402.

The aligned point cloud data 402 may be used to construct a relatively high-quality ground level estimate of an area surrounding a vehicle, which in certain instances herein may be referred to as a heightmap, using a heightmap formation process 414. For example, using the aligned point cloud data 402, a point column data structure formation process 416 and a ground level estimation process 418 may be used to generate a global BEV heightmap 420 representative of an area surrounding a vehicle.

Images 424 from a vehicle vision sensor system (e.g., cameras), which may comprise 360° RGB images, may be projected “against” the heightmap to generate a global “pseudo-satellite” BEV RGB image 430 representative of an area surrounding a vehicle. For example, an RGB image projection process 428 may use the global BEV heightmap 420 and/or data generated by the point column data structure formation process 416, captured RGB images 414, camera parameters 426, and/or other data generated through transformation and/or refinement processes 422 applied to data generated by the point cloud alignment process 412 to generate a global BEV RGB image 430.

In various embodiments, point cloud data may be processed in connection with various aspects of the disclosed systems and methods using a variety of techniques including, for example and without limitation, outlier stripping, spherical augmentation, extended interactive closest point (“ICP”) determination, stochastic density adjustment, and/or the like. Column sampling data structures may be employed that allow for data structure ray tracing for depth image creation. Ground level estimation techniques used in connection with generating the heightmap may, in some embodiments, use kernel density estimation (“KDE”) approximation techniques.

Outlier Stripping

In certain circumstances, LiDAR scans in presence of precipitation may exhibit noise close to the sensor due to light reflecting from airborne particles. For improved dataset tool functionality, LiDAR point cloud data should generally represent more solid surfaces in an environment surrounding a vehicle, with noise and/or outliers attributable to weather conditions filtered and/or otherwise reduced. Consistent with embodiments disclosed herein, a data processing algorithm may be used to strip obtained data of weather-related noise and/or outliers.

In various disclosed embodiments, for a point p to be preserved by a data outlier stripping algorithm consistent with certain embodiments disclosed herein, it may have Nₘᵢₙ other points in its neighborhood, which may be defined as space within Euclidean distance τ_{d} of point p. τ_{d} may be defined by Equation (1) below:

τ_{d}=τ+α∥p∥ (1)

where τ is the neighborhood range threshold, a a distance modifier and ∥p∥ the point's distance from the origin. In some embodiments, the LiDAR sensor may be defined to be at the position of the origin. Because distance between points may increase linearly with the distance from origin, a distance correction term α∥p∥ may be used to compensate for the increasing volumetric sparsity.

Algorithm: LiDAR Point Cloud Outlier Stripping

A non-limiting example of an outlier stripping algorithm consistent with various aspects of the disclosed embodiments is provided below:

```
  Inputs:
  : Point cloud to be processed
  : Neighbourhood range threshold
  α : Neighbourhood threshold distance modifier
  Nₘᵢₙ : Number of required neighbour points
  Output:
  _{new} : Processed point cloud
procedure STRIPOUTLIERS(  , , α, Nₘᵢₙ)
```

| | |
|---|---|
| _{new} ← { } | Stripped point cloud, initially empty |

for each p ϵ do

| | |
|---|---|
| _{d} ← + α\|\|p\|\| | Distance-corrected neighbourhood threshold |

N ← 0

| | |
|---|---|
| for each q ϵ \ {p} do | Count neighbours for point p |

```
        if ||p − q|| <   _{d} then
          N ← N + 1
        end if
      end for
      if N ≥ Nₘᵢₙ then  Sufficient number of neighbours, point p is preserved
        _{new} ← _{new}     {p}
      end if
    end for
    return _{new}
end procedure
```

Spherical Augmentation

LiDAR scanners designed for automotive applications may have uneven beam distribution, where more vertical resolution is allocated around the horizontal angle parallel to the ground. This may be justifiable to enable greater resolution for obstacle and object detection, but due to sparsely populated ground plane point clouds produced by such scanners, they may be not as well suited for terrain reconstruction.

To increase point cloud density in sparse areas, embodiments of the disclosed systems and methods provide processes for augmenting the point clouds via spherical coordinate projection. A non-limiting example of a method for augmenting point cloud data consistent with various aspects of the disclosed embodiments is provided below:

1. Project point cloud P into equirectangular radial distance map R∈ ^{s}^{ₕ}^{,s}^{ᵥ} and weight map W∈ ^{s}^{ₕ}^{,s}^{ᵥ}. Points projected on the same element may be weighted using kernel k(q, q_{c}), with projected point q and element centroid q_{c}. sₕ and sᵥ may indicate the horizontal and vertical resolution, respectively.

2. Project each element in R back to a 3D point, unless the corresponding polar angle θ is outside the limits [θₘᵢₙ, θₘₐₓ]. If the element is unassigned (i.e., corresponding weight in W is 0), distance for the element may be interpolated between nearest assigned elements along the vertical dimension.

Elements R_{i,j} in the radial distance map may be calculated as a weighted sum of the radial distance r(q) of the projected points q∈ _{i,j} on the element. Elements W_{i,j} in the weight map may calculated as the sum of the weights k(q, q_{c}). Non-limiting examples of calculation of the radial distance and weight maps are presented in Equations 2 and 3 below.

$${R}_{i , j} = {\sum }_{q ∈ {i , j}_{}} k ( q , {q}_{c} ) r ( q ) \qquad Eq . ( 2 )$$

$${W}_{i , j} = {\sum }_{q ∈ {i , j}_{}} k ( q , {q}_{c} ) \qquad Eq . ( 3 )$$

For the weight kernel k(q, q_{c}), an inverse distance function defined by Equation 4 may be used. The rationale behind such kernel may rise from an assumption that LiDAR measurements are relatively accurate, so a point landing in the middle of an element may get affected relatively little by surrounding points. ϵ may be a non-zero stability term to prevent division by zero and exceedingly large weights.

$$k ( q , {q}_{c} ) = \frac{1}{‖ q - {q}_{c} ‖ + ϵ} , \{ q , {q}_{c} \} ∈ {2}^{} , ϵ > 0 \qquad Eq . ( 4 )$$

To create interpolated points along a linear line between two vertically aligned elements corresponding to polar angles θ₁, θ₂ and distances d₁, d₂, a geometric problem may be solved. In the geometric problem, θ₃ may represent the polar angle of an element that lies within range [θ₁, θ₂] and d₃ the unknown, corresponding distance for 3D point projection. The problem can be expressed by forming an equation using the side-angle-side area formula for triangles. With some manipulation, represented in Equations 5-7, a formula for d₃ can be attained, as described by Equation 8 below.

$${Δθ}_{13} = {θ}_{3} - {θ}_{1} \qquad Eq . ( 5 )$$

$${Δθ}_{32} = {θ}_{2} - {θ}_{3} \qquad Eq . ( 6 )$$

$${Δθ}_{12} = {Δθ}_{13} + {Δθ}_{32} = {θ}_{2} - {θ}_{1} \qquad Eq . ( 7 )$$

$$\frac{1}{2} {d}_{1} {d}_{2} sin {Δθ}_{12} = \frac{1}{2} {d}_{1} {d}_{3} sin Δ {θ}_{13} + \frac{1}{2} {d}_{3} {d}_{2} sin Δ {θ}_{32} \\ {d}_{3} = \frac{{d}_{1} {d}_{2} sin Δ {θ}_{12}}{{d}_{1} sin Δ {θ}_{13} + {d}_{2} sin Δ {θ}_{32}} \qquad Eq . ( 8 )$$

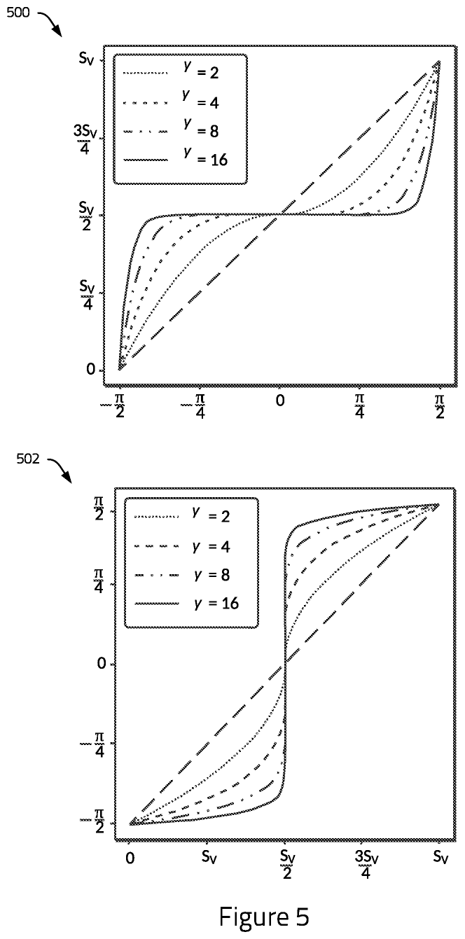

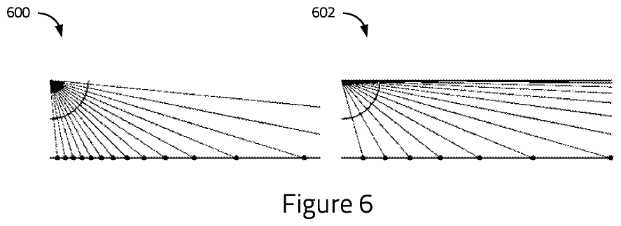

Point projection with linear polar angle with respect to the element's vertical index may result in a relatively dense point cloud for ground and objects near the vehicle. Furthermore, as LiDAR beams may be concentrated around the horizontal angle, in some instances a majority of the projective resolution may be used on areas with fewer points. Thus, details of the original point cloud may not be well preserved without usage of prohibitively large resolution. To address these issues, a nonlinear function may be used for the projection polar angle. The nonlinear function n(θ|sᵥ, γ) and its inverse n⁻¹ (q_{y}|sᵥ, γ) may be defined by Equation 9 and Equation 10 below, plotted respectively in graphs 500, 502 shown in FIG. 5. FIG. 6 illustrates a non-limiting example of the effects of a polar angle project nonlinearization scheme consistent with certain embodiments disclosed herein, with diagram 600 illustrating constant angle difference and diagram 602 illustrating varying angle difference. As can be seen in the diagrams 600, 602, projected points in the ground plane are relatively densely packed when using linear polar relative to when a nonlinear angle range is used.

$$\text{?} \qquad Eq . ( 9 )$$

$$\text{?} \qquad Eq . ( 10 )$$

$$\text{?} \text{indicates text missing or illegible when filed}$$

Extended ICP

ICP may be used in connection with aligning two 3D point clouds with rigid transformation (e.g., rotation and translation). With ICP, the rotation minimizing least-squares error between two point clouds sharing a centroid can be computed with singular value decomposition (“SVD”) of a 3×3 matrix. This may give the rotation alignment a computational complexity of O(n), where n is the number of points. In some embodiments, the rotation alignment assumes paired point sets P={p₁, p₂, . . ., p_{N}} and P′={p₁, p₂, . . . , p_{N}} so that:

p′ᵢ=Rpᵢ+t+σᵢ (11)

where R∈ ^{3×3} is the rotation matrix, t∈ ³ a translation vector, σᵢ, pointwise noise, and pᵢ,, p′ᵢ∈ R³ are the points before and after the transformation, respectively.

R and t may be computed to minimize the least-squares error e as shown in Equation 12 below:

$$e = {\sum }_{i = 1}^{N} {‖ {p}_{i}^{′} - ( {Rp}_{i} + t ) ‖}^{2} \qquad Eq . ( 12 )$$

However, in some practical cases, point clouds may not be pre-paired and therefore point pairing may be considered to belong in the problem domain. That is, matching point set P may be sampled from the target point cloud Q. For this purpose, an extension to the ICP alignment algorithm point may be used. A non-limiting example of the ICP algorithm consistent with various embodiments disclosed herein may be specified as follows:

1. On iteration j, for each point p_{i,j}, find a matching (i.e., closest) target point from target point cloud :

$${p}_{i , j}^{′} = arg {min}_{q ∈} ‖ q - {p}_{i , j} ‖ \qquad Eq . ( 13 )$$

2. Compute the alignment parameters R and t so that alignment error eⱼ (i.e., Equation 12) is minimized.

3. Apply the alignment:

p_{i,j+1}=R_{i,j}+t

i∈1, 2, . . . , N (14)

4. Terminate the iteration if sufficiently small change in alignment error has been reached: Δeⱼ<ϵ, where Δeⱼ=eⱼ₋₁−eⱼ and ϵ>0 is a sufficiently small constant indicating the desired iteration precision. Otherwise, proceed to the next iteration j+1.

In some circumstances, the standard ICP algorithm potentially fails to converge to optimal alignment unless sufficient initial conditions are met. These conditions may include, for example and without limitation, low noise, cloud point distribution similarity, and/or initial alignment. The reference point clouds may be noisy due to the aggregation of LiDAR scans. Furthermore, they may exhibit high variability in density as the resolution of the point cloud drops with respect to distance from the sensor according to the inverse-square law.

To address issues relating to higher convergence failure rate when aligning the reference cloud using the ICP algorithm consistent with embodiments disclosed herein, an extension to the algorithm may be used. The extension proposes replacement for the point matching step defined by Equation 13.

Instead of selecting matching point p_{i,j} directly from target point cloud , it may be computed by averaging points in neighborhood S,, defined by space within radius r from the point p_{i,j}. In case this neighborhood does not contain any points, the point is may be selected as in the ICP algorithm.

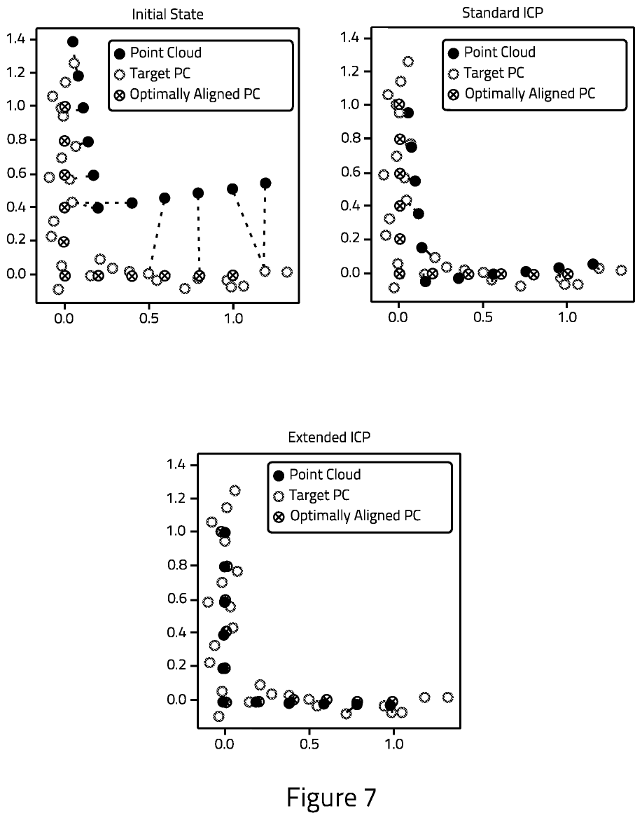

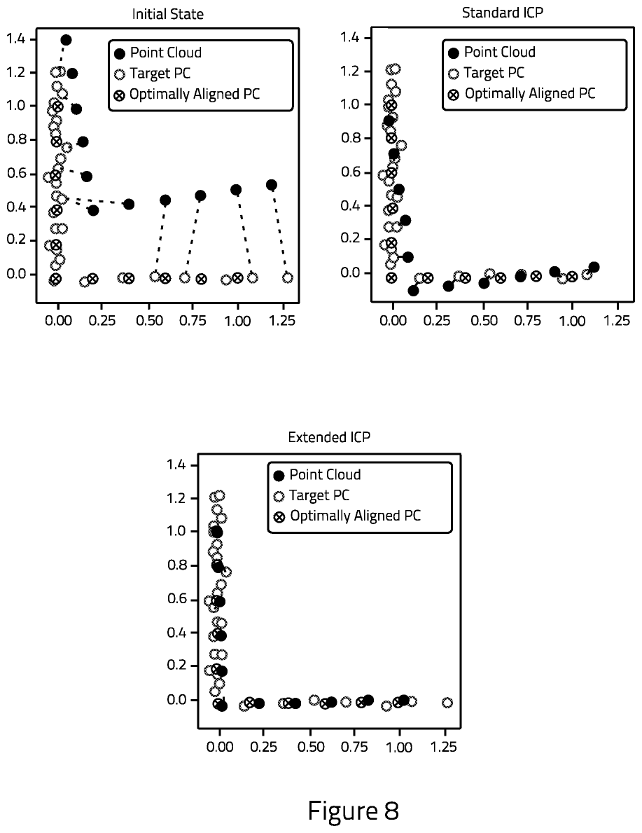

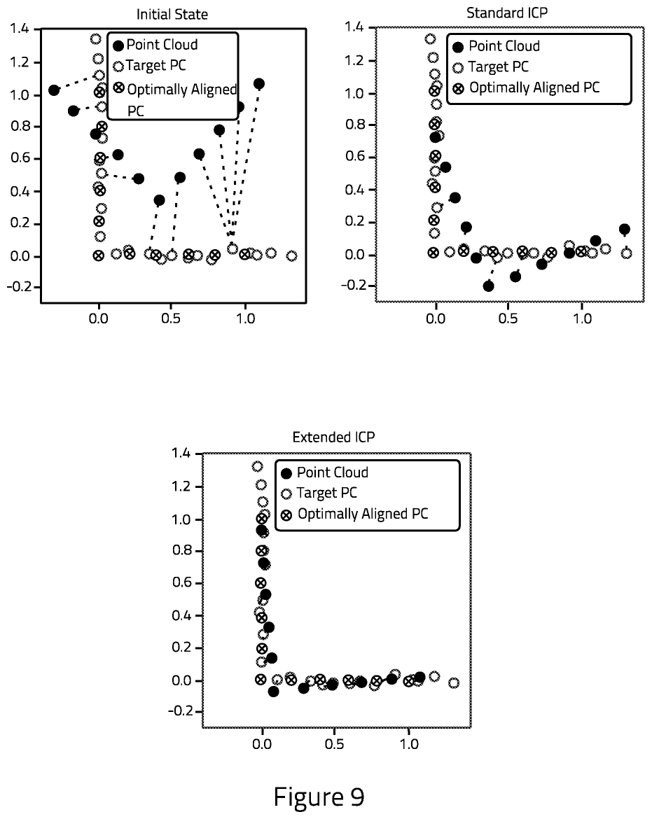

The extension consistent with various embodiments disclosed herein may be formulated in Equation 15. Non-limiting examples of its effectiveness in the presence of noise, density distribution dissimilarity, and poor initial alignment is presented in FIG. 7, FIG. 8, and FIG. 9 respectively, with ⋅ points representing the point cloud P to be aligned, ○ points representing the target point cloud , and ⊗ points representing the aligned point cloud in the figures.

$${𝒮}_{i , j} = \{ q ∈ : ‖ q - {p}_{i , j} ‖ < r \} \qquad Eq . ( 15 )$$

$${p}_{i , j}^{′} = \{ \begin{matrix}\frac{1}{\vert {𝒮}_{i , j} \vert} {\sum }_{s ∈ {𝒮}_{i , j}} s , \vert {𝒮}_{i , j} \vert > 0 \\ {arg min}_{q ∈} ‖ q - {p}_{i , j} ‖ , \vert {𝒮}_{i , j} \vert = 0\end{matrix}$$

Stochastic Density Adjustment

Merging augmented LiDAR point clouds may result in large point clouds with dense local clusters of points. Such clusters may contain redundant points and thus may cause distortion on methods operating on local regions of points (such as extended ICP methods). Furthermore, large point clouds comprising of hundreds of millions of points may be prohibitively slow to process on certain computing hardware. Consistent with embodiments disclosed herein, a method for reducing local density variance may be to remove points stochastically with probability proportional to the number of neighboring points.

In some embodiments, a stochastic approach may offer a measure of simplicity and/or robustness against potential aliasing of deterministic algorithms. A non-limiting density adjustment algorithm is described below: first, in similar fashion to outlier stripping, a number of neighborhood points are counted. After this, a removal probability ϕₚ for each point p is calculated; it may be determined by largest initial probability Φₘₐₓ (number of points in densest neighborhood), base removal probability ϕ₀, and a nonlinearity factor γ. With values γ>1, the removal process may concentrate on the densest clusters whereas values of γ∈(0, 1) may leave the sparsest areas untouched. ϕₚ may be computed as presented in Equation 16, below.

$${ϕ}_{p} = {ϕ}_{0} + ( 1 - {ϕ}_{0} ) {( \frac{N}{{Φ}_{max}} )}^{γ} \qquad Eq . ( 16 )$$

Algorithm: Stochastic Point Cloud Density Adjustment

A non-limiting example of a stochastic point cloud density adjustment algorithm consistent with various aspects of the disclosed embodiments is provided below:

Inputs:
: Point cloud to be processed
τ : Neighbourhood range threshold
ϕ₀ : Base removal probability
γ : Removal probability nonlinearity
Output:
_{new} : Processed point cloud
procedure ADJUSTDENSITY( ,τ,ϕ₀,γ)

| | |
|---|---|
| Φ ← { } | Set of removal probabilities |

```
  for each p ∈  do
    N ← 0
```

| | |
|---|---|
| for each q ∈ \ {p} do | Count neighbours for point p |

```
      if ∥p − q∥ < τ then
        N ← N + 1
      end if
    end for
```

| | |
|---|---|
| ϕₚ ← N | Probability of removal of point p |

```
    Φ ← {Φ,ϕₚ}
  end for
  Φₘₐₓ ← max(Φ)
  for each p ∈  do
```

| | |
|---|---|
| ${ϕ}_{p} ← {ϕ}_{0} + ( 1 - {ϕ}_{0} ) {( \frac{{ϕ}_{p}}{{Φ}_{max}} )}^{γ}$ | Update ϕₚ to final value |

end for

| | |
|---|---|
| _{new} ← { } | Density adjusted point cloud, initially empty |

```
  for each p ∈  do
    if ϕₚ < (X ~ U(0,1)) then   U(0,1) denotes an uniform pr. distribution
      _{new} ←  _{new} ∪ {p}
    end if
  end for
  return  _{new}
end procedure
```

Transformation Registration

Producing an accurate heightmap may involve precise transformation for each LiDAR scan in a driving sequence. A naive implementation may use a local alignment algorithm (such as the ICP) to obtain transformations between consecutive scans. However, such approach may cause drifting—accumulation of error on subsequent transformations. Good quality GNSS+INS localization data may help alleviate this. Despite precise localization, in some circumstances, using raw transformations based on GNSS+INS data alone may not provide sufficient point cloud alignment further away from the vehicle due to potential orientation inaccuracies.

In some embodiments, to compute accurate transformations for each frame, a two-step approach may be used: first, a reference point cloud may be formed based on the GNSS+INS localization data. Second, each LiDAR point cloud frame may be aligned to the reference point cloud using the extended ICP algorithm. In some implementations, method may combine the benefits of the two naive approaches, providing relatively precise alignment on frames with minimal and/or with reduced drifting error.

Reference Point Cloud Formation

To merge LiDAR point clouds of frames into a global reference point clouds, relative transformations between the point clouds may be acquired. By treating the initial vehicle transformation as origin, transformation ᵢ∈ ^{4×4} for frame i can be expressed with initial orientation R₀∈ ^{4×4}, frame i orientation Rᵢ∈ ^{4×4} and initial frame to frame i translation T₀ᵢ∈ ^{4×4}, as presented in Equation 17.

$${Q}_{i} = {R}_{0}^{- 1} {T}_{0 i} {R}_{i} \qquad Eq . ( 17 )$$

$${R}_{i} = {R}_{z} ( α ) {R}_{y} ( β ) {R}_{x} ( γ ) \qquad Eq . ( 18 )$$

$${T}_{0 i} = [ \begin{matrix}1 & 0 & 0 & Δ x \\ 0 & 1 & 0 & Δ y \\ 0 & 0 & 1 & Δ z \\ 0 & 0 & 0 & 1\end{matrix} ] \qquad Eq . ( 19 )$$

The transformations may be expressed as 4×4 homogeneous matrices, enabling compact notation that includes translations. Rₓ, R_{y} and R_{z} denote rotations along the x, y and z axes, respectively. α, β and γ denote yaw (i.e., azimuthal angle), pitch and roll, respectively. Δx, Δy and Δz denote translation along each axis. Angles and z-position (i.e., altitude) may be available in the GNSS+INS data provided by the dataset. Δx and Δy may be attained by a projection from latitude/longitude coordinates. This may be done by planar projection with initial location as reference, using for example a WGS84 coordinate system standard and a library for cartesian conversion. Curvature of the earth may be negligible for distances present in the dataset, justifying the approximation.

If LiDAR scans were to be merged unprocessed, the resulting point cloud may exhibit density variance to the extent of making subsequent alignment unstable. Particularly the ground may suffer from point scarcity since an extent of the LiDAR scan lines may be focused around a horizontal angle. To address this issue, point clouds may be first processed with a spherical augmentation algorithm. However, due to the interpolative nature of the spherical augmentation algorithm, it may be sensitive to airborne noise caused by precipitation. Therefore the noise may be first filtered out with an outlier stripping algorithm consistent with various disclosed embodiments.

After the merging, the global point cloud may again suffer from uneven density caused by the vehicle trajectory and the projective nature of the original point clouds. The merged point cloud may be denser around areas where the vehicle has moved slowly or remained stationary due to accumulation of scans (e.g., 10 times per second), regardless of the vehicle speed.

Additionally, points cloud sections closer to origin may be denser than those further away. Furthermore, the resulting point clouds may be prohibitively large to be used in the alignment phase. In some embodiments, these problems may be synergistically solved by removing points from the densest sections with a stochastic density adjustment algorithm consistent with embodiments disclosed herein. The algorithm may be repeated with increasing range threshold τ and nonlinearity factor γ until sufficiently low point count has been reached.

Alignment to Reference Point Cloud

Due to the uneven distribution of points in LiDAR scans, they may be not readily suitable for alignment with the extended ICP algorithm. In similar fashion to the processing done in the reference point cloud formation phase, the clouds may be first stripped of noise and spherically augmented. In addition, stochastic density adjustment may be applied to increase alignment stability.

After alignment, the transformations may be stored for future use. In some embodiments, the alignment phase could be executed in iterative manner by forming a new reference point cloud from the aligned clouds. In some implementations of the disclosed embodiments, however, it may be sufficient to perform the alignment once.

Heightmap Formation

Ground level estimation for a driving sequence s may be a function defined by z_{g}=h(x, y|s), which gives a ground level estimate z_{g} (with respect to sequence origin) for point (x, y) on the horizontal plane. In some embodiments, for the estimation to be feasible, its computational cost may be sufficiently low to accommodate for ground area covered by a single driving sequence.

If a 3D point cloud were to be used directly as the estimator, evaluation of h may involve point search over the cloud and processing of multiple points, giving such algorithm (with acceleration structure such as k-d tree) a lower bound complexity of O(log(n)+m), where n is the number of points in the cloud and m the number of points involved in the ground level estimate processing. In some embodiments, to project the RGB images and form the heightmap frames for a single sequence, the estimator may to be evaluated ˜2·10⁷ times. With an ordinary, modern PC computer, this approach may not yield results in reasonable time frame. For improved efficiency, the point clouds may be stored into a 2D column sampling data structure that can be used to effectively produce a ground level estimate and subsequent heightmap.

Column Sampling Data Structure

As the ground estimator h is a function of a 2D point, a reasonable starting point for its formation may be to reduce the 3D point cloud into a 2D form. To achieve this, the point cloud may be first discretized into a data structure consisting of point columns of size l×l. A column may be implemented as a dynamic array of point z-coordinates (in some embodiments, x and y may be omitted in discretization). l may denote the desired cell edge size of the resulting heightmap in real-world units.

To allow for efficient and flexible memory usage, the data may be structured into blocks of W×H columns. This may enable the structure to grow spatially without reallocation or wasting memory on empty areas. In some embodiments, to produce a reliable ground level estimate, one or more factors may be considered. Firstly, point distribution along z-dimension might be multimodal and/or not centered around the ground level; such may be the case when overhead (e.g., traffic signs, power lines, trees, bridges, etc.) or non-stationary (e.g., vehicles, pedestrians, etc.) objects are present. Secondly, for desired heightmap resolution there might be little or no points occurring inside each column, resulting in severe noise or “holes” in the heightmap.

To address these issues, spatial filtering methods may be used. Inside a column, point distribution may be modeled with KDE. The resulting distributions may be horizontally filtered to fill and smooth the defects caused by insufficient number of column points.

Ground Level Estimation with KDE

First vertical point density distributions may be formed using gaussian kernels with bandwidth σ. A non-limiting example of a vertical kernel density estimator f_{c}(z) for column c consistent with various disclosed embodiments is presented below in Equation 20. P_{c} may denote points inside a column c. As evaluation of the density function may involve computing kernel with respect to each point in the column, horizontal filtering may become computationally difficult. Consistent with embodiments disclosed herein, an approximation method for the density function may be used.

$${f}_{c} ( z ) = \frac{1}{\vert {c}_{} \vert} {\sum }_{p ∈ {c}_{}} k ( {p}_{z} - z ) \qquad Eq . ( 20 )$$

$${k}_{v} ( z \vert σ ) = \frac{1}{σ \sqrt{2 π}} {e}^{- \frac{1}{2} {( \frac{z}{σ} )}^{2}} \qquad Eq . ( 21 )$$

In some circumstances, column points may tend to form clusters representing ground and objects in the scene. These clusters may be approximately normally distributed and can therefore be modeled as macroscopic (e.g., larger than the kernel kᵥ(z|σ)) parametrized gaussians. This may reduce the number of gaussian evaluations per column from the number of points (|P_{c}|) to number of clusters (e.g., <5 in some implementations).

A non-limiting example of a parametrized gaussian g(z|α, μ, σ) consistent with various aspects of the disclosed embodiments is presented below in Equation 22, with α as the peak height, μ as the center of the peak, and a as the width of the gaussian. The quadratic error function may be defined as a squared sum of differences of approximation \hat{f}_{c}(z) and the original density function f_{c}(z) at evaluation points _{E}, as presented below in Equation 23.

$$g ( z \vert a , μ , σ ) = {ae}^{- \frac{1}{2} {( \frac{z - μ}{σ} )}^{2}} \qquad Eq . ( 22 )$$

$${E}_{c} = {\sum }_{z ∈ {E}_{}} {( {\hat{f}}_{c} ( z ) - {f}_{c} ( z ) )}^{2} \qquad Eq . ( 23 )$$

In at least one non-limiting example, an outline for an approximator formation algorithm may be defined as follows:

1. Find arguments of the local maxima ₘₐₓ of f_{c}(z) using Newton's method and fixed interval sampling for initial points.

2. Initialize parametrized gaussians according to the maxima (with μ∈ ₘₐₓ and α∈f( ₘₐₓ)).

3. Fit parametrized gaussians into the density function f_{c}(z) using gradient descent for a quadratic error function E_{c}.

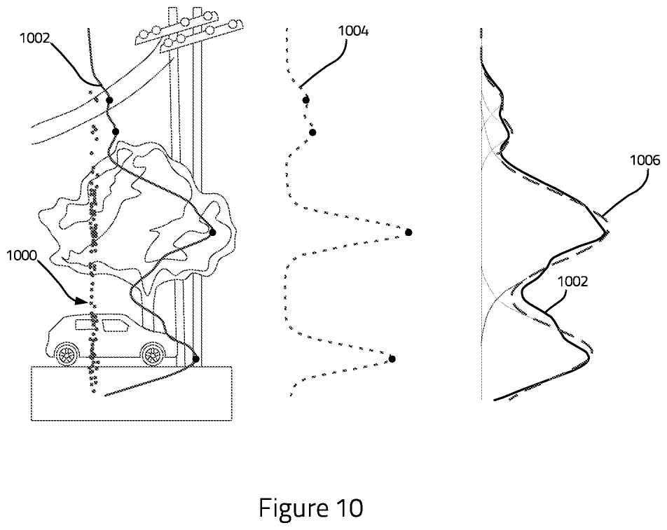

FIG. 10 illustrates a non-limiting example of a KDE approximation process consistent with certain embodiments disclosed herein. As shown, a point sample column 1000 may be used to determine a density function f_{c}(z) 1002 using KDE approximation techniques. An initial approximation with parametrized gaussians based on peaks 1004 may be obtained. A final fitted approximation \hat{f}_{c}(z) 1006 may be generated consistent with embodiments disclosed herein. As shown, the fitted approximation \hat{f}_{c}(z) 1006 provides a relatively accurate representation of the original density function f_{c}(z) 1002 determining using a full KDE process.

As a result of its computationally optimized nature, the KDE approximator function \hat{f}_{c}(z) may be suitable for horizontal filtering. Horizontal filtering may be implemented as a weighted sum of columns C, presented in Equation 25, using a 2D gaussian weight kernel kₕ(Δx, Δy), presented in Equation 24.

$${k}_{h} ( Δ x , Δ y \vert σ ) = \frac{1}{σ \sqrt{2 π}} {e}^{- \frac{1}{2} ( \frac{{Δ}_{x}^{2} + {Δ}_{y}^{2}}{{σ}^{2}} )} \qquad Eq . ( 24 )$$

$${\tilde{f}}_{c} ( z ) = {\sum }_{d ∈ C} {k}_{h} ( {x}_{d} - {x}_{c} , {y}_{d} - {y}_{c} \vert σ ) {f}_{d} ( z ) \qquad Eq . ( 25 )$$

The filtered density estimate \tilde{f}_{c}(z) may be used for ground level estimation. In some embodiments, maxima for the filtered estimate \tilde{f}_{c}(z) may first be found in similar manner to the original KDE f_{c}(z). In at least one non-limiting example implementing certain embodiments disclosed herein, the ground level estimate for a column c may be chosen to be the lowest argument of a maximum corresponding to a value of at least of 10% of the global maximum max \tilde{f}_{c}(z). The soft selection may be justified based on the relatively lower likelihood of any significant peaks being under the ground level besides outliers caused by noise and/or point cloud misalignment.

RGB Image Projection

Consistent with various disclosed embodiments, to form the global BEV RGB image as a reference for a labeler (e.g., a human labeler and/or an automated and/or semi-automated labeler), RGB camera images may be projected against the heightmap. Image distortion correction, camera parameters, and/or corresponding depth imaging may be used for successful projection. Distortion correction calibration parameters and/or intrinsic and extrinsic parameters for cameras and/or other vision sensor systems may be used in connection with global BEV RGB image generation. In some embodiments, a depth image may be formed by virtually imaging the 3D heightmap using ray tracing and storing length-to-contact for each ray.

Camera Parameters and Distortion Correction

In some embodiments, a homogeneous 3D world point p_{w}∈ ⁴ can be projected into point in pixel coordinates pₚ∈ ³ with a pinhole camera model, in which the camera is modeled with two matrices. An extrinsic parameter matrix [R|t] may encode the camera's rotation in matrix R∈ ^{3×3} and its translation in vector t∈ ³. With the extrinsic parameter matrix, the point in world space may be transformed into point in camera space p_{c}, as presented in Equation 26. This point may be projected into pixel coordinates with intrinsic parameter matrix A formed from focal lengths fₓ, f_{y} and principal point location cₓ, c_{y}, as presented in Equation 29. The projection may be presented in Equation 27. In some embodiments operations can be combined to transform a world point into pixel coordinates as presented below.

$${p}_{c} = [ R \vert t ] {p}_{w} \qquad Eq . ( 26 )$$

$${p}_{p} = {Ap}_{c} \qquad Eq . ( 27 )$$

$${p}_{p} = A [ R \vert t ] {p}_{w} \qquad Eq . ( 28 )$$

$$A = [ \begin{matrix}{f}_{x} & 0 & {c}_{x} \\ 0 & {f}_{y} & {c}_{y} \\ 0 & 0 & 1\end{matrix} ] \qquad Eq . ( 29 )$$

With p_{wz}≠0, the post-depth-division projection can be reformed into Equation 30, presented below. In this form the distortion correction can be applied by replacing p_{wx}/p_{wz} and p_{wy}/p_{wz} with x″ and y″ as presented in Equation 31. For the distortion correction, a computer vision library such as, for example and without limitation, OpenCV, may be used. The computer vision library may use a distortion correction model presented in Equations 32-34. In the equations, k₁₋₆ may be the radial distortion coefficients, q₁, q₂ the tangential distortion coefficients, and s₁₋₄ the thin prism distortion coefficients.

$$[ \begin{matrix}{p}_{px} \\ {p}_{py}\end{matrix} ] = [ \begin{matrix}{f}_{x} ( {p}_{wx} / {p}_{wz} ) + {c}_{x} \\ {f}_{y} ( {p}_{wy} / {p}_{wz} ) + {c}_{y}\end{matrix} ] \qquad Eq . ( 30 )$$

$$[ \begin{matrix}{p}_{px} \\ {p}_{py}\end{matrix} ] = [ \begin{matrix}{f}_{x} {x}^{′′} + {c}_{x} \\ {f}_{y} {y}^{′′} + {c}_{y}\end{matrix} ] \qquad Eq . ( 31 )$$

$$[ \begin{matrix}{x}^{′′} \\ {y}^{′′}\end{matrix} ] = [ \begin{matrix}{x}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {q}_{1} {x}^{′} {y}^{′} + {q}_{2} ( {r}^{2} + 2 {x}^{′2} ) + {s}_{1} {r}^{2} + {s}_{2} r \\ {y}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + {q}_{1} ( {r}^{2} + 2 {y}^{′2} ) + 2 {q}_{2} {x}^{′} {y}^{′} + {s}_{3} {r}^{2} + {s}_{4} r\end{matrix} \qquad Eq . ( 32 )$$

$$[ \begin{matrix}{x}^{′} \\ {y}^{′}\end{matrix} ] = [ \begin{matrix}{p}_{wx} / {p}_{wz} \\ {p}_{wy} / {p}_{wz}\end{matrix} ] \qquad Eq . ( 33 )$$

$${r}^{2} = {x}^{′2} + {y}^{′2} \qquad Eq . ( 34 )$$

In certain embodiments, the distorted images may be undistorted to enable world points to be transformed into pixel positions, and pixel positions to be transformed into projective lines with a linear matrix A [R|t] (and its inverse).

Ray Tracing

In various disclosed embodiments, ray tracing (and/or its Monte Carlo variant, path tracing) may be used for offline (e.g., non-real-time) rendering. Ray tracing may be based on the concept of simulating light transport in reverse manner; instead of simulating rays of light emitted from a light source, they are “emitted” from the camera into the scene geometry.

Consistent with various disclosed embodiments, at least one non-limiting example of a ray tracing algorithm may comprise three phases: (1) ray-geometry intersection determinations, (2) transmission on geometry contact (e.g., reflection, refraction, dispersion, etc.) determinations, and (3) material modeling. In certain applications, ray tracing may render a matching depth image corresponding to an undistorted camera view and not necessarily a photorealistic representation, which may allow for a simplified process that does not include phases (2) or (3).

The ray may be modeled with a point of origin o, a normalized direction vector \hat{d} and ray length t, as presented in Equation 35. In some embodiments, geometry for each column may be modeled with bilinear interpolation, with corner heights ∈ ^{2×2}, as presented in Equation 36 and Equation 37. For a local points inside a column (sₓ, s_{y}∈[0, 1]), height difference to the bilinear surface can be calculated with g(s| ), presented in Equation 38. Every points with g(s| )<0 may be considered to be below the ground and therefore a geometry contact. By replacing s with the parametrization of a localized ray r(t|õ, \tilde{d}) and finding roots for ray length t, the equation presented in Equation 39, the contact point can be resolved. Ray normalization may in some embodiments be performed using Equation 40, Equation 41, Equation 42, and Equation 43 below.

r(t|o, \hat{d})=o+t\hat{d}, o, \hat{d}∈ ³, ∥\hat{d}∥=1 (35)

i(x|a, b)=a+x(b−a), x∈[0, 1] (36)

i₂(x, y|Q)=i(y|i(x|Q₁₁, Q₁₂), i(x|Q₂₁, Q₂₂)), x, y∈[0,1], Q∈ ^{2×2} (37)

g(s|Q)=s₂−i₂(sₓ, s_{y}|Q), s∈ ³, sₓ, s_{y}∈[0, 1] (38)

g(r(t|õ, d̅)|Q)=0 (39)

ōₓ=(oₓ−c_{g1})/(cₓ₂−cₓ₁) (40)

ō_{y}=(o_{y}−c_{g1})/(c_{y2}−c_{y1}) (41)

d̅ₓ=d_{z}/(cₓ₂−cₓ₁) (42)

d̅_{y}=d_{y}/(c_{y2}−c_{y1}) (43)

With respect to t, g(r(t|õ, \tilde{d})| ) can be refactored into a second order polynomial, as presented in Equations 44-47 below. Contact points may be resolvable with the quadratic formula.

g(r(t|õ, \tilde{d})|Q)=at²+bt+c, (44)

a=\hat{d}ₓ\hat{d}_{y}(Q₁₂+Q₂₁ −Q₁₁−Q₂₂) (45)

b=\hat{d}_{z}+Q₁₁(\hat{d}ₓ+\hat{d}_{y}+\hat{d}_{y}õₓ−\hat{d}ₓõ_{y})−Q₂₂(\hat{d}_{y}õₓ+\hat{d}ₓõ_{y})+Q₁₂(\hat{d}_{y}õₓ+\hat{d}ₓõ_{y}−\hat{d}ₓ)+Q₂₁(\hat{d}_{y}õₓ+\hat{d}ₓõ_{y}−\hat{d}_{y}) (46)

c=õ_{z}−₁₁(1+õₓ+õ_{y}−õₓõ_{y})−õₓQ₁₂−õ_{y}Q₂₁+õₓõ_{y}(Q₁₂+Q₂₁−Q₂₂) (47)

To create a ray, its origin may be chosen to be the position of the camera “pinhole” and its direction a vector in the direction of negative z axis, projected with inverse of the camera matrix. This may produce a ray for each pixel “traveling” to negative direction with respect to light rays in undistorted RGB image. Each ray may contact the ground geometry at multiple points, of which the nearest (e.g., smallest t) is chosen for the corresponding pixel.

In practice, computing every intersection between multiple megapixel size images and 10⁷ columns (≈10¹⁴ intersections for each frame) may be a computationally difficult task. Accordingly, optimization techniques may be used. In some embodiments, an acceleration structure may be used, reducing the complexity of the rendering algorithm from O(n) to O(log(n)), where n is the number of geometry elements. In some embodiments, a common such structure such as a bounding volume hierarchy (“BVH”) may be used, in which the geometry elements may be grouped into hierarchically growing groups with bounding volumes surrounding them. In such structure, each ray may be intersected at most with a number of volumes equal to the depth of the hierarchy.

General bounding volumes, however, can be computationally demanding to construct to enable reasonable performance for all kinds of geometries. In connection with various disclosed embodiments, the geometry may be a defined pseudo-dense grid pattern in x and y directions, allowing for a different approach. The square nature of each column block is exploited to form a 2.5D quadtree, each level of the hierarchy being an axis-aligned bounding box (“AABB”) with minimum and maximum height values chosen so that successive levels are contained within the limits.

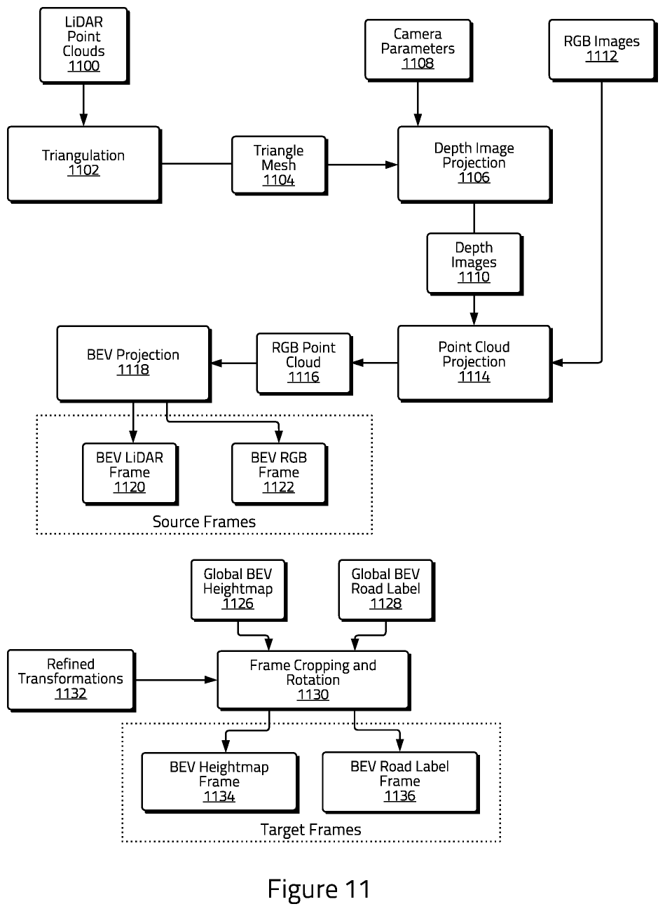

FIG. 11 illustrates a conceptual diagram of a non-limiting example of a second aspect of processing sensor data for training a machine learning model consistent with certain embodiments disclosed herein. Input-output pairs of BEV frames, which may represent a snapshot of an environment surrounding a vehicle at a given time, may be generated. Input frames may be produced in real time. Output frames may comprise rotated and/or cropped images from a global BEV heightmap, potentially with associated labeling information. In connection with generating BEV LiDAR and RGB frame information, various triangulation and/or RGB image projection techniques may be employed.

For example, as shown in FIG. 11, LiDAR point cloud data 1100 may be provided to a triangulation process 1102 to generate corresponding triangle mesh data 1104. The triangle mesh data 1104 may be provided to a depth image projection process 1106 which may use the triangle mesh data 1104, potentially in connection with applicable camera and/or other vision sensor parameters 1108, to generate depth images 1110. The generated depth images 1110 may be provided to a point cloud projection process 1114 which may generate RGB point cloud data 1116 based on the depth images and available RGB images 1112. The RGB point cloud data 1116 may be provided to a BEV projection process 1118 which may generate corresponding BEV LiDAR frame data 1120 and BEV RGB frame data 1122.

In certain embodiments, a frame cropping and/or rotation process 1130 may generate a BEV heightmap frame 1134 and a BEV road label frame 1136. For example, the frame cropping and/or rotation process 1130 may receive global BEV heightmap data 1126 and global BEV road label data 1128 and generate the BEV heightmap frame 1134 and BEV road label frame 1136 based on the received global BEV heightmap data 1126 and global BEV road label data 1128. In some embodiments, the frame cropping and/or rotation process 1130 may further use one or more provided refined transformations 1132 in connection with generating the BEV heightmap frame 1134 and the BEV road label frame 1136.

RGB and LiDAR BEV frames may comprise both tensors with dimensions of N×N×3. As such, they can be represented as regular RGB images (with a floating-point data type). With the vehicle origin centered at (N/2, N/2), a frame may to a surrounding area of Nl×Nl, where l is the cell edge length in real-world units.

The LiDAR frame channels may encode density, height, and intensity of the LiDAR point cloud. Density may be the number of points inside a l×l column. Height and intensity may be the average z-position and reflection intensity of the points. For the RGB frame BEV projection, the RGB images may be projected against the 3D geometry of an environment. Naively the environment could be modeled as a plane below the vehicle. However, such approach may cause projective distortions in environments with height variations and obstacles. Consistent with certain embodiments disclosed herein, an algorithm may be used that takes advantage of the line sweep structure of the LiDAR point clouds, allowing for the point cloud to be triangulated into a triangle mesh in real and/or near real-time. Graphics processing units (“GPUs”) may be designed for effectively rasterizing triangle meshes and therefore the resulting mesh can be projected into the camera views to form depth images corresponding to the RGB images. With the help of the depth images, the RGB images can be projected into 3D points to form the BEV image. In certain embodiments, for the BEV image, the color of the topmost point may be chosen.

LiDAR Frame

BEV LiDAR frames may be formed directly from the LiDAR scan point clouds by projection and averaging operations for efficiency. Cells (e.g., pixels) p_{LIDAR,c}∈ ² corresponding to column c in the frame may encode a column point density ρ_{c}, average height z_{c,avg} and average reflective intensity Φ_{c,avg}, as presented below in Equation 49.

$${p}_{LiDAR , c} = [ \begin{matrix}{x}_{LiDAR , c} \\ {y}_{LiDAR . c}\end{matrix} ] \qquad Eq . ( 48 )$$

$${d}_{LiDAR , c} = [ \begin{matrix}\begin{matrix}{ρ}_{c} \\ {z}_{c , avg}\end{matrix} \\ {Φ}_{c , avg}\end{matrix} ] \qquad Eq . ( 49 )$$

$${ρ}_{c} = \vert {c}_{} \vert \qquad Eq . ( 50 )$$

$${z}_{c , avg} = \frac{1}{{ρ}_{c}} {\sum }_{p ∈ {c}_{}} {z}_{p} \qquad Eq . ( 51 )$$

$${Φ}_{c , avg} = \frac{1}{{ρ}_{c}} {\sum }_{p ∈ {c}_{}} {Φ}_{p} \qquad Eq . ( 52 )$$

RGB Frame

Producing a BEV RGB frame may be more difficult than producing a BEV LiDAR frame due there being no 3D structure in 2D RGB images. Therefore, the RGB images may be projected into 3D points. To achieve this, in various embodiments, corresponding depth images providing distance from the camera origin for each pixel may be used. Embodiments of the disclosed systems and methods may use hardware rasterization capabilities of modern GPUs. By triangulating the LiDAR point cloud into a triangle mesh, it can be rendered into depth images by utilizing the camera parameters, which may be provided in an applicable dataset such as, for example and without limitation, the Canadian Adverse Driving Conditions (“CADC”) dataset. Finally each RGB image may be backprojected into a 3D point cloud and projected into a BEV image. For a RGB pixel value d_{RGB,c}=[r_{RGB,c} g_{RGB,c} b_{RGB,c}]^{T} corresponding to column c the RGB value of the topmost (e.g., highest z value) point may be chosen.

LiDAR Point Cloud Triangulation

Algorithms for reconstructing a triangle mesh provide relatively high quality results but may involve additional spatial analysis for coherent results. One such method may be based on isosurface polygonization of a signed distance field. Embodiments of the disclosed systems and methods may reconstruct triangle mesh from LiDAR scans by exploiting the scanline structure of the point clouds. Points belonging to scanlines may be separated at specific polar angles, according to the specifications of the LiDAR sensor. Subsequent scanlines may then be connected by addressing point pairs in sequence determined by their azimuthal angle. One of the lines may be treated as a pivot, and points from the other line may be connected to the active point until it is surpassed, in which case the line designations are swapped. This may result in an algorithm of linear complexity O(n). A non-limiting example of a full triangulation algorithm consistent with various embodiments disclosed herein is outlined below:

$$p = [ \begin{matrix}{x}_{p} \\ {y}_{p} \\ {z}_{p}\end{matrix} ]$$

1. Convert each point in LiDAR point cloud P to spherical coordinates

$${p}_{s} = [ \begin{matrix}{r}_{p} \\ {θ}_{p} \\ {ϕ}_{p}\end{matrix} ]$$

and save them into a new array Pₛ.

2. Sort Ps according to polar angle Oₚ.

3. Split the sorted Pₛ into lines L_{l-Nl} by finding indices of points splitting the lines. In some embodiments, split angles may be chosen according to the LiDAR sensor specification.

4. Sort lines L_{l-Nl} according to azimuthal angle ϕₚ.

5. Connect two consecutive line points p_{s,i,j}, p_{s,i,j+1}∈Lᵢ to form an edge and add their indices to E in case the difference ϕ_{p s,i,j+1}−ϕ_{p s,i,j} is larger than a minimum required difference Δϕₘᵢₙ.

6. Connect two lines Lᵢ and Lᵢ₊₁ with the non-limiting example of an algorithm for connecting two spherical coordinate point lines provided below:

```
Inputs:
ᵢ : First sorted line of points
ᵢ₊₁ : Second sorted line of points
Δϕₘᵢₙ : Minimum required azimuthal angle difference
  : Pre-existing edges
Output:
  : Updated edges with added connective edges
procedure CONNECTLINES( ᵢ, ᵢ₊₁,Δϕₘᵢₙ,  )
```

| | |
|---|---|
| _{new} ← { } | Stripped point cloud, initially empty |

| | |
|---|---|
| $j ← [ \begin{matrix}1 \\ 1\end{matrix} ]$ | Indices of active points in lines |

| | |
|---|---|
| a ← 1 | Connecting line index |

| | |
|---|---|
| b ← 2 | Pivot line index |

while j₁ < | ᵢ| ∨ j₂ < | ᵢ₊₁| do

| | |
|---|---|
| Δϕ ← − | Difference between active points az. angles |
| if Δϕ < 0 then | Swap pivot and connecting line designations |

```
      c ← a
      a ← b
      b ← c
    else
```

| | |
|---|---|
| if \|Δϕ\| < Δϕₘᵢₙ then | Create and store the edge |

```
          ←   ∪ {{{i + a − 1,jₐ},{i + b − 1,j_{b}}}}
      end if
```

| | |
|---|---|
| jₐ ← jₐ + 1 | Increase point index of the. connecting line |

```
    end if
  end while
  return
end procedure
indicates data missing or illegible when filed
```

7. Form triangles T from edges Eby finding cycles of length 3.

8. Transform each triangle t={p_{t,1}, p_{t,2}, p_{t,3}}∈T to counterclockwise indexing with respect to the origin by swapping p_{t,2} and p_{t,3} in case ((p_{t,2}−p_{t,1})×(pₜ₃−p_{t,1}))·p_{t,1}>0.

9. Filter out all triangles with normal-to-origin angle γ exceeding a chosen threshold γmax. A non-limiting example for γ is presented below in Equation 53.

$$γ = ( \frac{( {p}_{t , 2} - {p}_{t , 1} ) \times ( {p}_{t , 3} - {p}_{t , 1} )}{‖ ( {p}_{t , 2} - {p}_{t , 1} ) \times ( {p}_{t , 3} - {p}_{t , 1} ) ‖} ) \cdot ( - \frac{{p}_{t , 1}}{‖ {p}_{t , 1} ‖} ) \qquad Eq . ( 53 )$$

Triangle Mesh Rasterization

The triangle mesh may be rasterized (in some embodiments with the OpenGL graphics application programming interface (“API”)), enabling efficient formation of depth images from a triangle mesh. Rasterization may be achieved with a virtual camera encompassing a frustum-shaped rendering volume. In some embodiments, this can be achieved by forming a projection matrix from the camera intrinsic matrix A, near and far clipping plane distances d₁, d₂ and image width and height w, h, as described by Equation 54 below.

$${A}_{OpenGL} = [ \begin{matrix}\frac{2 {A}_{1 , 1}}{w} & \frac{- 2 {A}_{1 , 2}}{w} & \frac{w - 2 {A}_{1 , 3}}{w} & 0 \\ 0 & \frac{2 {A}_{2 , 2}}{h} & \frac{- h + 2 {A}_{2 , 3}}{h} & 0 \\ 0 & 0 & \frac{- {d}_{2} - {d}_{1}}{{d}_{2} - {d}_{1}} & \frac{- 2 {d}_{2} {d}_{1}}{{d}_{2} - {d}_{1}} \\ 0 & 0 & - 1 & 0\end{matrix} ] \qquad Eq . ( 54 )$$

Depth images may be created by rendering the world coordinate for each pixel. This may be made possible by passing a camera extrinsic parameter matrix to a vertex shader and transforming each vertex with it. In result, the rasterizer interpolator may efficiently assign the correct world position for each rendered pixel. Thus, the depth image can be created by calculating the Euclidean distance from each pixel's rendered world position to the camera origin.

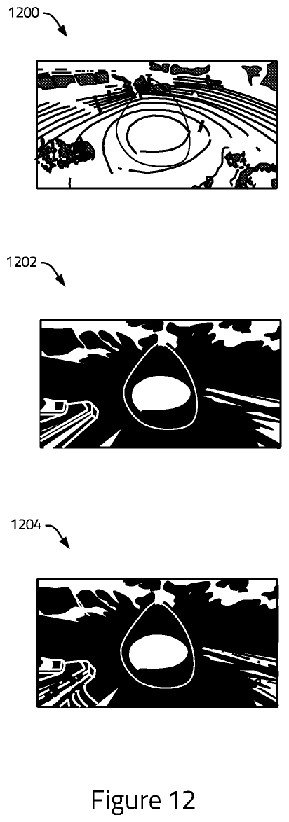

With the rendered depth images, the camera RGB images can be projected into a 3D point cloud, which consequently can be BEV-projected to create the RGB BEV frame. FIG. 12 illustrates a non-limiting example of the results of LiDAR point cloud triangulation and image projection consistent with certain embodiments disclosed herein. Specifically, the figure illustrates a representation of an original LiDAR point cloud 1200, a corresponding triangulated mesh 1202, and a corresponding point cloud projected with RGB and depth images 1204.

Heightmap/Road Label Frames

In some embodiments, the global BEV heightmap and road label frames may be incorporated with metadata regarding their resolution and coordinate origin. This may enable cropping of the target (e.g., heightmap and road label) frames to be sampled from the global BEV images directly with an affine transformation. The affine transformation Uᵢ for frame i can be constructed from the frame vehicle transformation ᵢ, a global BEV image resolution-based scaling factor s and global BEV image origin location (oₓ, o_{y}). A non-limiting example of the derivation of Uᵢ is presented in Equations 55-59 below. The final frame may be produced by cropping a region of desired size around origin from transformed global BEV image.

$${f}_{i} = [ \begin{matrix}{Q}_{i , 1 , 1} \\ {Q}_{i , 2 , 1}\end{matrix} ] \qquad Eq . ( 55 )$$

$${\hat{f}}_{i} = \frac{{f}_{i}}{‖ {f}_{i} ‖} \qquad Eq . ( 56 )$$

$${T}_{U , i} = [ \begin{matrix}1 & 0 & - {sQ}_{1 , 4} - {o}_{x} \\ 0 & 1 & {sQ}_{2 , 4} - {o}_{y} \\ 0 & 0 & 1\end{matrix} ] \qquad Eq . ( 57 )$$

$${R}_{U , i} = [ \begin{matrix}{f}_{1} & - {f}_{2} & 0 \\ {f}_{2} & {f}_{1} & 0 \\ 0 & 0 & 1\end{matrix} ] \qquad Eq . ( 58 )$$

$${U}_{i} = {( {R}_{U , i} {T}_{U , i} )}^{- 1} \qquad Eq . ( 59 )$$

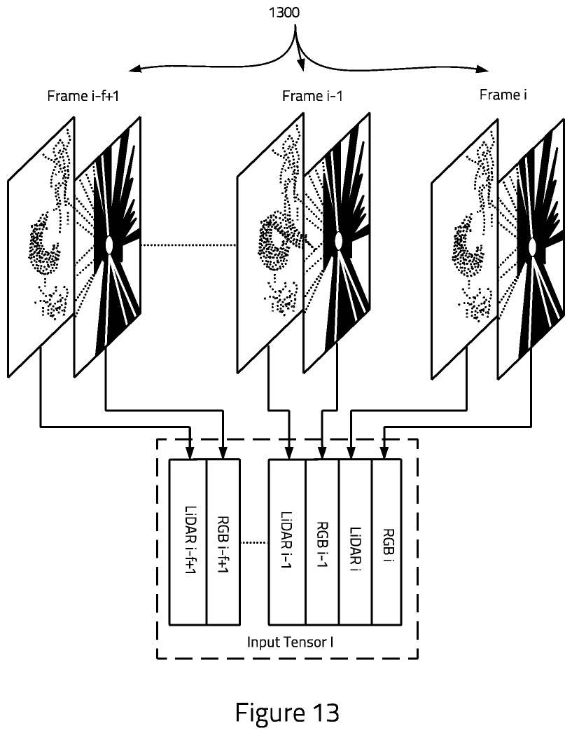

FIG. 13 illustrates a non-limiting example of frame concatenation consistent with certain embodiments disclosed herein. In certain instances, an individual frame alone may not contain sufficient information to provide a clear understanding of an environment surrounding a vehicle due to the presence of occlusions and/or noise. As illustrated in connection with FIG. 13, in various embodiments, multiple frames 1300 (e.g., multiple LiDAR and/or RGB BEV frames) may be concatenated together. For example, in some embodiments, a current frame may be concatenated with a plurality of prior frames.

Neural Network Prediction Models

Various neural network meta-architectures for prediction of the heightmap and road label frames may be used in connection aspects of the disclosed embodiments including, for example and without limitation, fully convolutional encoder-decoder meta-architectures and/or a corresponding U-Net equivalent (e.g., similar structure with skip connections). A U-Net architecture may be suitable for road detection from summertime satellite pictures, and thus may be considered a suitable solution due to its relative simplicity and computational efficiency. Encoder-decoder architectures may be considered as a baseline in purpose of evaluating the impact of the skip connections.

Various network architectures may comprise recurring structures of several layers which may be referred to as modules. Each of the modules may perform a semantical operation forming the basis for algorithm construction of well-defined network architectures.

In some embodiments, at least three modules may be used in connection with various disclosed embodiments including, for example and without limitation, a convolution module, a downscale module, and an upscale module.

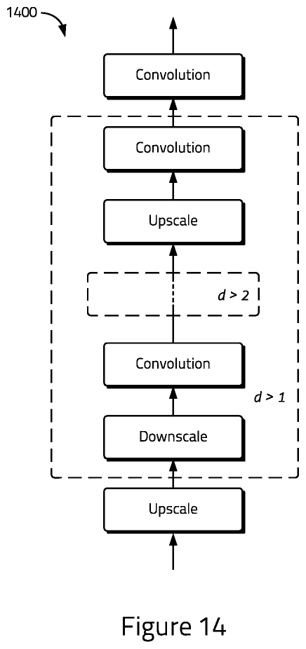

FIG. 14 illustrates a first non-limiting example of a machine learning model training network architecture 1400 consistent with certain embodiments disclosed herein. In certain embodiments, encoder-decoder networks based on convolutional neural networks and/or autoencoders may be employed in connection with model training. Input data may be compressed into lower resolution features as part of an encoding process. Features may be decompressed into desired predictions for the model (e.g., road labeling, height mapping, etc.). Parameters for the model training may comprise, for example and without limitation, resolution, number of input frames, convolution kernel size, model depth, and/or the like).

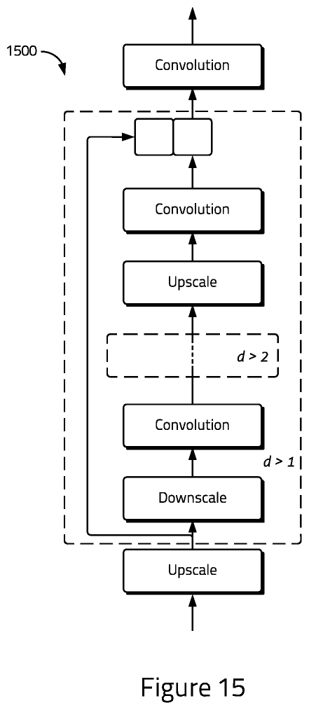

FIG. 15 illustrates a second non-limiting example of a machine learning model training network architecture 1500 consistent with certain embodiments disclosed herein. In certain embodiments, U-Net convolutional neural network techniques may be employed in connection with model training, potential with skip connection and concatenation visualized. Successive layers may be used in connection with up sampling operators to increase the resolution of the network output. Parameters for the model training may comprise, for example and without limitation, resolution, number of input frames, convolution kernel size, model depth, and/or the like.

In various embodiments, the illustrated architectures 1400, 1500 of FIG. 14 and FIG. 15 may be defined as recurse, nest structures with respect to a depth hyperparameter d. Maximum depth may be constrained by the fact that tensor with dimension subject to scaling of size 1 may not be further downscaled. With the 2×2 down/upscaling ratio used in the networks this can be formulated as dₘₐₓ=[log₂ (min(n, m))]+1 for an input tensor I∈ ^{n×m×6f}.

The convolution and downscale modules may use convolutional kernel of size k×k, where k is another architecture-defining hyperparameter. After each downscale layer a number of channels may be doubled. For encoder phase modules, a dropout rate of

$${σ}_{l} = σ - \frac{l - 1}{10}$$

may be used, where a is the base dropout hyperparameter and l denotes depth of the recursion level.

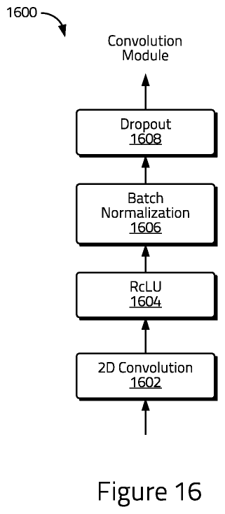

A non-limiting example of a convolution module 1600 illustrated in FIG. 16. The convolution module 1600 may conserve the input resolution and may comprise three layers including, for example and without limitation, a 2D convolution layer 1602, a rectified linear unit (“ReLU”) nonlinearity layer 1604, and a batch normalization layer 1606. The module can be defined with a dropout rate of greater than 0, in which case a dropout layer 1608 may also be included. The convolution layer may use c k×k convolution kernels, in some implementations with both parameters configurable. Batch normalization may use a momentum term of 0.99 for moving mean and average, and ϵ of 0.001.

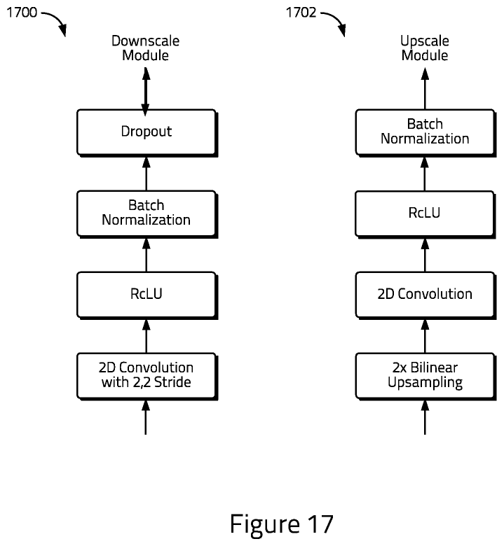

Downscale and upscale modules may perform the encoding and decoding tasks, respectively. Non-limiting examples of a downscale module 1700 and an upscale module 1702 are illustrated in connection with FIG. 17. In some embodiments, encoding and decoding tasks may be achieved by reducing and increasing the spatial resolution of the network while altering the number of channels in a manner prominent in most convolutional architectures. Instead of pooling, however, the downscaling may be performed with strided convolutions. This may enable the network to learn the more useful downscaled representation of the data (in contrast to the fixed, non-parametric functionality of pooling layers typically used for the task). Thus the 2×2 striding may be the differing factor between convolution and downscale modules. In some embodiments, upscaling may be done by adding a bilinear up sampling layer with magnification ratio of 2×2 in front of a l×l convolution.

In some embodiments, upscale modules may not use dropout layers, as they may not be proved to be beneficial in the decoding stage. Instead, upscale modules may be followed by a convolution module, enabling information flow over a larger area than is enabled by the up sampling and l×l convolutional layer.

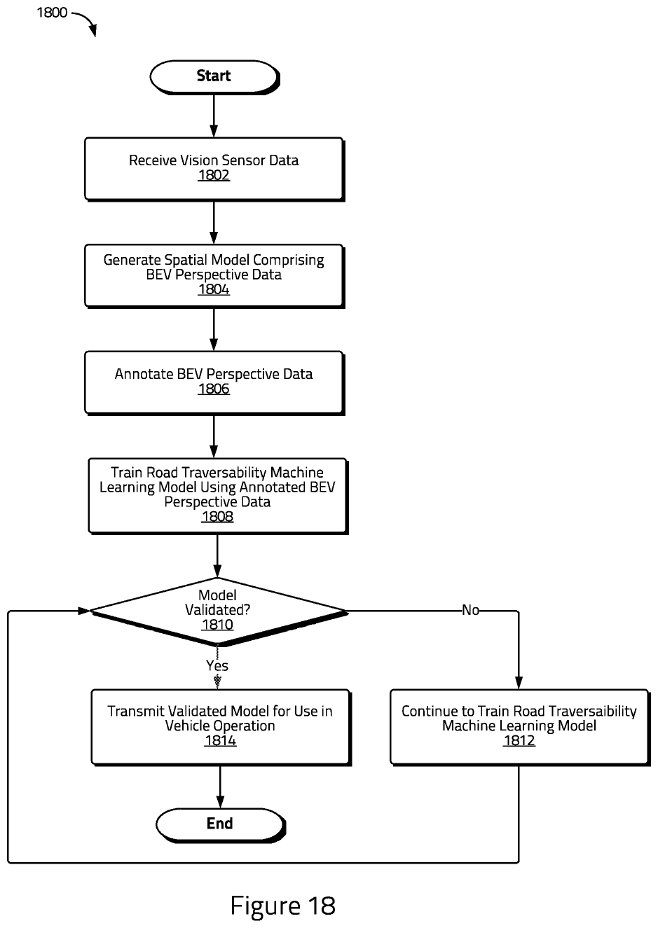

FIG. 18 illustrates a flow chart of a non-limiting example of a method 1800 of training and validating a machine learning model for determining road traversability consistent with certain embodiments disclosed herein. The illustrated method 1800 may be implemented in a variety of ways, including using software, firmware, and/or any combination thereof. In certain embodiments, various aspects of the method 1800 and/or its constituent steps may be performed by a cloud service, a vehicle management system, network edge processing systems, a vehicle system, and/or any other service and/or system and/or combinations of services and/or systems that may be used to implement various aspects of the disclosed systems and methods.

At 1802, first vision sensor system data generated by one or more vehicle vision sensor systems may be accessed. In some embodiments, the first vision sensor system data may comprise LiDAR sensor data and/or camera sensor data, obtained respectively from LiDAR sensor system(s) and camera sensor system(s) associated with a vehicle, which may comprise a testing vehicle. In certain embodiments, the first vision sensor system data may comprise data captured by a plurality of vision sensor systems under a plurality of different weather conditions (e.g., reference and/or otherwise ideal weather conditions, adverse weather conditions where road boundary markers and/or lane boundary markers are totally and/or partially obscured and/or otherwise difficult to identify, etc.). Further embodiments of the disclosed systems and methods may use raw test and/or characterization data obtained on roadways with no lane markings (e.g., as may be the case with a gravel road)

Based on the first vision sensor system data received at 1802, a first spatial model representative of the first vision sensor system data may be generated at 1804. In some embodiments, the first spatial model may provide a representation of an area and/or environment surrounding the vehicle. Consistent with embodiments disclosed herein, the first spatial model may comprise a cohesive spatial model generated by fusing the first light detection and ranging sensor data and the first camera sensor data to generate first BEV perspective data.

At 1806, the first BEV perspective data may be annotated (e.g., automatically, manually, semi-automatically under supervision of a user, and/or the like). In some embodiments, the first BEV perspective data may be annotated by identifying and/or otherwise labeling one or more first road boundaries within the spatial model and/or the BEV perspective data. In further embodiments, one or more first lane boundaries may be identified, which may be located within an area defined by the one or more first road boundaries.

Consistent with embodiments disclosed herein, a predictive machine learning model may be trained at 1808 by providing the model with the first birds eye view perspective data as a training input and the annotated first birds eye view perspective data as a corresponding training output. The model may be refined and/or may adjust one or more model parameters based on relationships identified between the first birds eye view perspective data and the annotated road and/or boundary information of the annotated first birds eye view perspective data.

The trained model may be validated at 1810. In some embodiments, validating the trained model may comprise accessing second vision sensor system data generated by a plurality of vision sensor systems associated with a vehicle, generating a second spatial model based on the second vision sensor system data, annotating the second birds eye view perspective data to identify one or more second road boundaries and one or more second lane boundaries associated with the second birds eye view perspective data, and providing the trained predictive machine learning model with the second birds eye view perspective data as a training input to generate predicted annotated birds eye view perspective data.

The predicted annotated birds eye view perspective data generated by the trained predictive machine learning model may be compared with the annotated second birds eye view perspective data, and a determination may be made whether the predicted annotated birds eye view perspective data is within a specified threshold level based on the comparison. If the prediction is within the threshold, the model may be considered validated, and the method 1800 may proceed to 1814 where it may be deployed to one or more vehicle systems and/or associated systems and/or services for use in road traversability determinations and/or control operations. If not, the model may be continued to be trained at 1812 consistent with various disclosed embodiments until it is deemed validated.

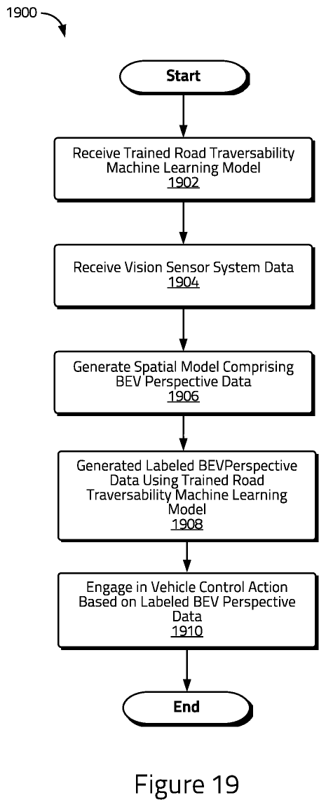

FIG. 19 illustrates a flow chart of a non-limiting example of a method 1900 of using a validated trained machine learning model in connection with road traversability determinations in a vehicle consistent with certain embodiments disclosed herein. The illustrated method 1900 may be implemented in a variety of ways, including using software, firmware, and/or any combination thereof. In certain embodiments, various aspects of the method 1900 and/or its constituent steps may be performed by a cloud service, a vehicle management system, network edge processing systems, a vehicle system, and/or any other service and/or system and/or combinations of services and/or systems that may be used to implement various aspects of the disclosed systems and methods.

At 1902, a trained, and potentially validated, machine learning model for determining road traversability may be received. Vision sensor system data generated by a plurality of vision sensor systems associated with the vehicle (e.g., LiDAR and/or camera systems) may be received at 1904. In some embodiments, the vision sensor system data may comprise LiDAR sensor data and/or camera sensor data.

Based on the vision sensor system data, a spatial model representative of an area and/or environment surrounding the vehicle may be generated at 1906. In some embodiments, the spatial model may comprise a cohesive spatial model generated by fusing available LiDAR sensor data and/or camera sensor data. Consistent with various embodiments disclosed herein, the spatial model may comprise birds eye view perspective data.

At 1908, using the trained machine learning model, labeled birds eye view perspective data may be generated based on the birds eye view perspective data included in the spatial model. In some embodiments, the labeled birds eye view perspective data may comprise information identifying one or more road boundaries within the birds eye view perspective data. In some embodiments, the method 1900 may further comprise identifying one or more lane boundaries within an area defined by the one or more road boundaries (e.g., as part of the model process and/or a separate lane boundary labeling process). In certain embodiments, one or more lane boundaries may be identified based, at least in part, on a determine location of a vehicle obtained by vehicle location systems (e.g., GPS and/or other location systems) and available mapping information. For example, it may be determined that a vehicle is at a location corresponding to a roadway that has two travel lanes based on available mapping information, which may be used in connection with lane boundary identification processes consistent with various disclosed embodiments.

In some embodiments, the method 1900 may further comprise determining a lateral position of the vehicle within a lane defined by the one or more lane boundaries. A difference between the lateral position of the vehicle within the lane and a mid-lane position within the lane may be determined. If the difference between the lateral position of the vehicle within the lane and the mid-lane position within the lane differ by a specified threshold, the method 1900 may proceed to 1910 and at least one vehicle control action may be implemented. For example, in some embodiments, a control signal may be generated and transmitted to at least one vehicle control system configured to reduce the difference between the lateral position of the vehicle within the lane and the mid-lane position within the lane.

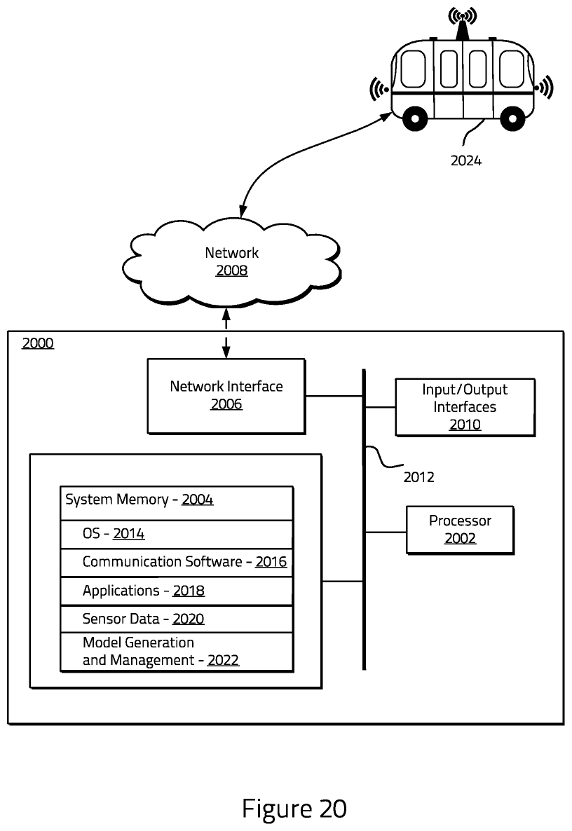

FIG. 20 illustrates an example of a system 2000 that may be used to implement certain embodiments of the systems and methods of the present disclosure. Although illustrated as a remote processing system 2000 separate from a vehicle 2024, it will be appreciated that certain elements associated with the illustrated system 2000 may be included in processing systems and/or resources included in a vehicle 2024 and/or in communication with a vehicle 2024 via low latency network connections (e.g., edge cloud and cloud processing resources) configured to implement aspects of the embodiments of the systems and methods disclosed herein.

As illustrated in FIG. 20, the system 2000 may include: a processing unit 2002; system memory 2004, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 2002; a port for interfacing with one removable memory that may include one or more diskettes, optical storage mediums, and/or other non-transitory computer-readable storage mediums (e.g., flash memory, thumb drives, USB dongles, compact discs, DVDs, solid state drives, etc.); a network interface 2006 for communicating with other systems (including systems associated with an AV 2024) via one or more network connections 2008 using one or more communication technologies and/or channels; a user interface 2010 that may include a display and/or one or more input/output devices such as, for example, a touchscreen, a keyboard, a mouse, a track pad, and the like; and one or more buses 2012 for communicatively coupling the elements of the system.

The operation of the system 2000 may be generally controlled by the processing unit 2002 by executing software instructions and programs stored in the system memory 2004 and/or internal memory of the processing unit 2002. The system memory 2004 may store a variety of executable programs or modules for controlling the operation of the system 2000. For example, the system memory 2004 may include an operating system (“OS”) 2014 that may manage and coordinate, at least in part, system hardware resources and provide for common services for execution of various applications, modules, and/or services.

The system memory 2004 may further comprise, for example and without limitation, communication software 2016 configured to enable in part communication with and by the system 2000; one or more applications 2018; sensor data 2020, which may comprise vehicle sensor system data, road traversability machine learning model generation, management, training, and/or validation engines and/or modules 1024 configured to perform various functions of relating to model generation, management, training, validation, and use, aspects thereof, and/or related functions and/or operations consistent with various aspects of the disclosed embodiments; and/or any other information and/or applications configured to implement embodiments of the systems and methods disclosed herein.

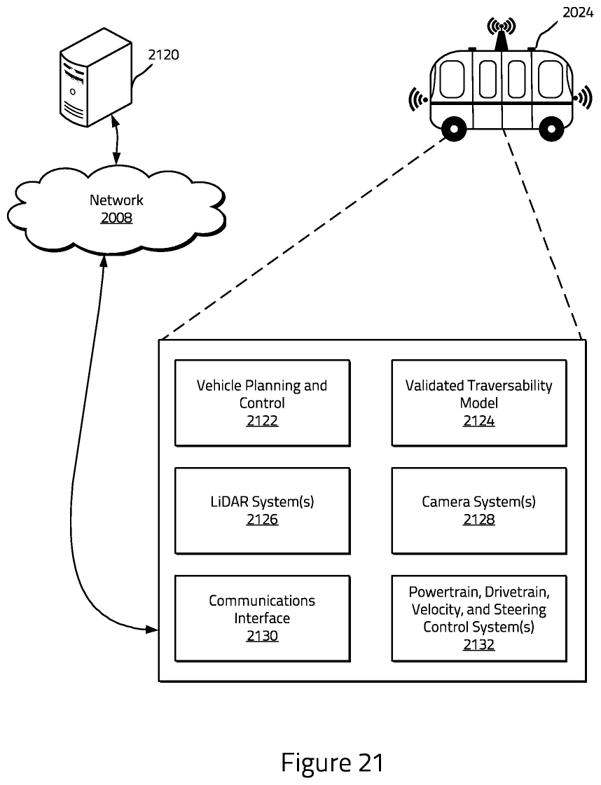

FIG. 21 illustrates a non-limiting example of a simplified vehicle architecture that may be used to implement certain embodiments of the systems and methods of the present disclosure. Although illustrated as separate components and/or systems 2122-2132 included in a vehicle 2024, which may comprise any type of vehicle described herein and/or equivalents thereof, it will be appreciated that certain components and/or systems 2122-2132 may be combined in a single component and/or system and/or any suitable combination and/or combinations of systems and/or components. For example and without limitation, in certain embodiments, the illustrated validated traversability model 2124 may be stored by and/or otherwise managed by the route planning and control system 2122.

As illustrated, the vehicle 2024 may comprise a route planning and control system 2122; a validated traversability model 2124 which may be used by route planning and/or control systems 2122 to implement certain road and/or vehicle traversability determinations and/or certain other aspects of the disclosed embodiments; one or more LiDAR systems 2126; one or more camera systems 2128; other sensor systems (e.g., RADAR systems, location systems, etc.); one or more communication interfaces 2130; which may be configured to enable the vehicle 2024 and/or its constituent components and/or systems 2122-2132 to communicate with one or more remote management systems 2120, which may comprise a fleet management system, a cloud service system, an edge processing system, and/or any other system and/or service that may be in communication with the vehicle 2024 and/or its constituent components and/or systems 2122-2132, via a network 2008; vehicle powertrain, drivetrain, velocity, and/or steering control system(s) 2132 which may effectuate certain vehicle planning and control actions (e.g., based on control actions and/or commands issued by route planning and/or control systems 2122).

The components and/or systems 2122-2132 of the vehicle 2024 may be interconnected and/or otherwise be configured to communicate via one or more internal vehicle communication networks and/or busses, which may comprise, for example, one or more controller area network (“CAN”) interfaces, networks, and/or busses, and/or the like. Certain components and/or systems 2122-2132 may be implemented by one or more computer systems and/or processing devices and/or units, which may comprise internal and/or otherwise on-board computer systems and/or processing devices and/or units such as, for example, and without limitation, electronic control units (“ECUs”).

Consistent with various embodiments disclosed herein, the route planning and/or control system 2122 may use vision sensor data generated and/or otherwise collected by the LiDAR systems 2126 and/or camera systems 2128 to construct BEV perspective data. The BEV perspective data may be provided to the validated traversability model 2124, which may identify road and/or lane boundaries associated with the BEV perspective data consistent with various aspects of the disclosed systems and methods. The vehicle planning and/or control system 2122 may, based on the identified road and/or lane boundaries, determine one or more control actions (e.g., actions to ensure the vehicle 2024 travels within a desired path, does not deviate from a desired midlane position, and/or the like), and issue corresponding control actions and/or commands to applicable vehicle powertrain, drivetrain, velocity, and/or steering control systems 2132.

The systems and methods disclosed herein are not limited to any specific computer, device, service, or other apparatus architecture and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

It will be appreciated that a number of variations can be made to the architecture, relationships, and examples presented in connection with the figures within the scope of the inventive body of work. For example, certain illustrated and/or described processing steps may be performed by a single system and/or service and/or be distributed between multiple systems and/or services. Moreover, certain information processing workflows may be modified to include additional processing steps, eliminate certain processing steps, and/or reorder certain processing steps. Thus, it will be appreciated that the architecture, relationships, and examples presented in connection with the figures are provided for purposes of illustration and explanation, and not limitation.

Although the foregoing has been described in some detail for purposes of clarity, it will be apparent that certain changes and modifications may be made without departing from the principles thereof. It should be noted that there are many alternative ways of implementing both the systems and methods described herein. Moreover, it will be appreciated that any examples described herein, including examples that may not be specifically identified as non-limiting, should not be viewed as limiting and/or otherwise restrictive. Accordingly, the present embodiments are to be considered as illustrative and not restrictive, and the invention is not to be limited to the details given herein, but may be modified within the scope and equivalents of the appended claims.

What is claimed is:

1. A method of training a predictive machine learning model for determining road traversability by a vehicle, the method performed by a system comprising a processor and a computer-readable storage medium storing instructions that, when executed by the processor, cause the system to perform the method, the method comprising:
accessing first vision sensor system data generated by a plurality of vision sensor systems associated with a vehicle, the first vision sensor system data comprising first light detection and ranging sensor data and first camera sensor data;
generating, based on the first vision sensor system data, a first spatial model representative of the first vision sensor system data, the first spatial model comprising first birds eye view perspective data;
annotating the first birds eye view perspective data to generate annotated first birds eye view perspective data, wherein annotating the first birds eye view perspective data comprises identifying one or more first road boundaries and one or more first lane boundaries associated with the first birds eye view perspective data; and
training a predictive machine learning model to identify road boundaries by providing the predictive machine learning model with the first birds eye view perspective data as a training input and the annotated first birds eye view perspective data as a corresponding training output.

2. The method of claim 1, wherein the first spatial model representative of the first vision sensor data comprises a cohesive spatial model generated by fusing the first light detection and ranging sensor data and the first camera sensor data.

3. The method of claim 1, wherein annotating the first birds eye view perspective data comprises at least one of automatically annotating the first birds eye view perspective data, manually annotating the first birds eye view perspective data by a user, and automatically annotating the first birds eye view perspective data under the supervision of a user.

4. The method of claim 1, wherein the one or more first lane boundaries are located within an area defined by the one or more first road boundaries.

5. The method of claim 1, wherein the first vision sensor system data comprises data captured by the plurality of vision sensor systems under a plurality of different weather conditions.

6. The method of claim 5, wherein at least one of road boundary markers and lane boundary markers are not visible in at least one weather condition of the plurality of different weather conditions.

7. The method of claim 1, wherein the method further comprises validating the trained predictive machine learning model, wherein validating the trained predictive machine learning model comprises:
accessing second vision sensor system data generating by the plurality of vision sensor systems associated with the vehicle, the second vision sensor system data comprising second light detection and ranging sensor data and second camera sensor data;
generating, based on the second vision sensor system data, a second spatial model representative of the second vision sensor system data, the second spatial model comprising second birds eye view perspective data;
annotating the second birds eye view perspective data to generate annotated second birds eye view perspective data, wherein annotating the second birds eye view perspective data comprises identifying one or more second road boundaries and one or more second lane boundaries associated with the second birds eye view perspective data;
providing the trained predictive machine learning model with the second birds eye view perspective data as a training input to generate predicted annotated birds eye view perspective data;
comparing the predicted annotated birds eye view perspective data generated by the trained predictive machine learning model with the annotated second birds eye view perspective data; and
determining that the predicted annotated birds eye view perspective data generated by the trained predictive machine learning model is within a specified threshold level based on the comparison.

8. The method of claim 7, wherein the method further comprises transmitting the validated trained predictive machine learning model to an autonomous vehicle control system for use in autonomous operation.

9. A method for managing the operation of a vehicle performed by a system comprising a processor and a computer-readable storage medium storing instructions that, when executed by the processor, cause the system to perform the method, the method comprising:
receiving a trained machine learning model for determining road traversability;
receiving vision sensor system data generated by a plurality of vision sensor systems associated with the vehicle, the vision sensor system data comprising light detection and ranging sensor data and camera sensor data;
generating, based on the vision sensor system data, a spatial model representative of an area surrounding the vehicle, the first spatial model comprising birds eye view perspective data;
generating, by the trained machine learning model, labeled birds eye view perspective data by providing the birds eye view perspective data to the trained machine learning model as an input, the labeled birds eye view perspective data comprising information identifying one or more road boundaries within the birds eye view perspective data; and
engaging in at least one vehicle control action based on the labeled birds eye view perspective data.

10. The method of claim 9, wherein the spatial model representative of an area surrounding the vehicle comprises a cohesive spatial model generated by fusing the light detection and ranging sensor data and the camera sensor data.

11. The method of claim 9, wherein the method further comprises identifying one or more lane boundaries within an area defined by the one or more road boundaries.

12. The method of claim 11, wherein the one or more lane boundaries are identified in the labeled birds eye view perspective data generated by the trained machine learning model.

13. The method of claim 11, wherein the one or more lane boundaries are identified based on location information obtained by a location system of the vehicle and mapping information accessed by the system.

14. The method of claim 11, wherein the method further comprises determining a lateral position of the vehicle within a lane defined by the one or more lane boundaries.

15. The method of claim 14, wherein the method further comprises determining a difference between the lateral position of the vehicle within the lane and a mid-lane position within the lane.

16. The method of claim 15, wherein the method further comprises determining that the difference between the lateral position of the vehicle within the lane and the mid-lane position within the lane differ by a specified threshold.

17. The method of claim 16, wherein the engaging in the at least one control action comprises generating and transmitting a control signal to at least one vehicle control system configured to reduce the difference between the lateral position of the vehicle within the lane and the mid-lane position within the lane.

18. The method of claim 9, wherein the system comprises a route planning and control system included in a vehicle.

19. The method of claim 9, wherein the vehicle comprises at least one of a fully autonomous vehicle, a semi-autonomous vehicle, and a vehicle with a driver-assistance system.

20. A non-transitory computer-readable storage medium storing instructions that, when executed by a processor of a control system, cause the control system to perform operations comprising:
receiving a trained machine learning model for determining road traversability;
receiving vision sensor system data generated by a plurality of vision sensor systems associated with the vehicle, the vision sensor system data comprising light detection and ranging sensor data and camera sensor data;
generating, based on the vision sensor system data, a spatial model representative of an area surrounding the vehicle, the first spatial model comprising birds eye view perspective data;
generating, by the trained machine learning model, labeled birds eye view perspective data by providing the birds eye view perspective data to the trained machine learning model as an input, the labeled birds eye view perspective data comprising information identifying one or more road boundaries within the birds eye view perspective data; and
engaging in at least one vehicle control action based on the labeled birds eye view perspective data.
